(19) United States
(12) Patent Application Publication
(10) Pub. No.: US 2026/0112292 A1
(43) Pub. Date: Apr. 23, 2026

(54) CODING BLOCKS LEARNING SYSTEM AND METHOD

(71) Applicant: Georgia Tech Research Corporation, Atlanta, GA (US)

(72) Inventors: HyunJoo OH, Atlanta, GA (US); Jin YU, Atlanta, GA (US); DoangJoo SYNN, Atlanta, GA (US); Poojita GARG, Atlanta, GA (US)

(21) Appl. No.: 19/357,594

(22) Filed: Oct. 14, 2025

Related U.S. Application Data
(60) Provisional application No. 63/709,381, filed on Oct. 18, 2024.

(51) Int. Cl. G09B 19/00; G06F 8/41; G06T 7/50; G06T 7/73; G06V 20/62

(52) U.S. Cl. CPC G09B 19/0053; G06F 8/447; G06T 7/50; G06T 7/74; G06V 20/63

(57) ABSTRACT

An exemplary system and method are disclosed for facilitating users in building programs through an assembly of physical objects. In some implementations, the exemplary system and method include (i) a plurality of physical coding blocks and (ii) an interface configured to recognize a combined sequence of physical blocks in the assembly, extract programming functions or logics from the recognized combined sequence, and generate compilable or interpretable code for a software development environment that can be compiled thereon into computer-readable instructions to program electronic devices.

### RELATED APPLICATION

This application claims priority to, and the benefit of, U.S. Provisional Patent Application No. 63/709,381, filed Oct. 18, 2024, entitled “CODING BLOCKS LEARNING SYSTEM AND METHOD,” which is incorporated by reference herein in its entirety.

### BACKGROUND

Tangible programming, also known as physical or embodied programming, refers to the use of physical objects (e.g., blocks, cards, etc.) to teach computational thinking and programming concepts. In U.S. education, tangible programming has gained popularity in early childhood and K-12 classrooms due to its hands-on nature and alignment with experiential learning theories. By facilitating students to manipulate physical components to build logical sequences, tangible programming supports engagement and accessibility, especially for younger learners.

However, tangible programming has not achieved integration into mainstream curricula because various challenges, e.g., cost, teacher training, and limited scalability, have slowed its broader implementation. There is a benefit to improving the tangible programming systems and methods.

### SUMMARY

An exemplary system and method are disclosed that employs tangible physical block assemblies to define code elements that can be attachably and re-attachably coupled to one another to form a code block that can be translated into computer-readable instructions for use in a software development environment or platform. The computer-readable instructions, once generated, can be executed on a computer or an embedded electronic system (e.g., microcontroller). In some embodiments, the translation is performed via an interface software (e.g., online platform using computer-vision-based web-based interface software). The computer instructions can be compiled or interpreted for execution on a target computing device. The physical block assemblies may be made of plastic and cardboard as an article of manufacture or may be self-made at home.

MakeCodeTangible (MCT), and other like platforms, is an educational system that supports beginner coding education by integrating tangible programming via visual elements for learning basic and advanced coding concepts in a visual space. By integrating tangible programming using the code block with a specific design space for early education with a widely used platform like MakeCode, the exemplary system addresses the entry barriers in physical computing education and provides a hands-on learning environment. MCT enables students to create computational projects using tangible code blocks, capturing and converting them into MakeCode code and other platforms to enhance engagement, prototyping capacity, and motivation for future learning. MakeCode provides a very expansive programming environment that becomes a barrier for early learners. The design space that has been employed improves on MakeCode by making it hands-on and appropriate for early learners. The exemplary system and method draw inspiration from MakeCode and limit the vast options available in MakeCode and constrain the expansive development environment into tangible physical block and allows for programming employing those tangible physical block system to be imported into the original MakeCode environment.

In some implementations, the exemplary system and method include (i) a plurality of physical coding blocks (e.g., made from printed paper and cardboard) and (ii) an interface (e.g., web-based interface on a computing device) configured to recognize a combined sequence of physical blocks in the assembly, the interface being configured to extract programming functions or logics from the recognized combined sequence and generate compilable or interpretable code for a software development environment (e.g., Microsoft MakeCode) that can be compiled thereon into computer-readable instructions (e.g., .exe, assembly code) to program electronic devices (e.g., Micro:bit microcontroller).

Current tangible programming systems operate as isolated, standalone tools that cannot integrate with online software development environments/platforms. In contrast, as an improvement to the current tangible programming systems, the exemplary system and method are configured to integrate with online software development environments/platforms (e.g., MakeCode), facilitating users (e.g., children) to transition from physical block-based programming to digital code development, supporting both early engagement and long-term learning. While current tangible programming systems may limit learners to closed environments with little extensibility, restricting users to proprietary interfaces or disconnected learning experiences, the exemplary system and method can allow users to generate real, executable code (e.g., computer-readable instructions) at any level of experience in an expansive environment that allows user to start in this expansive environment in a constrained manner but then allow them to move beyond constrained, sandbox-style activities and engage in moderate and complex programming practices in the same programming ecosystem.

In some implementations, the physical coding blocks of the exemplary system and method are configured to be re-attachably and attachably assembled to form a block assembly representing a sequence of programming functions for use in a software development environment, which can then compile the sequence of programming functions, or an exported version thereof, to generate computer-readable instructions to operate a computer or embedded computing device. Instead of interacting with the complex interfaces of current programming tools that require coding knowledge, users of the exemplary system can form a tangible block assembly (also referred to as a coding puzzle) using physical blocks selected within an intentional design space for early and/or moderate learners, and without any prior programming experience, to represent a sequence of programming functions. Then, the exemplary system and method, via an interface, can translate the programming functions from an image or video acquired of the tangible blocks into code that can be exported to the software development environment to be compiled or interpreted to generate computer-readable instructions for a computing or embedded computing device. In some embodiments, the software development environment can be configured with the functions of the interface to add this additional functionality. To this end, the software development environment can be enabled to operate on physical tangible blocks and natively use its function set to import the physical tangible blocks as a programming sequence for editing and use by the user.

Each physical coding block has (i) texts and/or colors configured to represent programming elements, and (ii) shaped surfaces configured to enable the block to be assembled with other blocks to easily form a sequence of programming functions from the plurality of programming elements. In some embodiments, the translation by the interface can be performed using design elements encoded into the physical block, e.g., text-only. In such elements, the text in the physical blocks may be imprinted on the blocks in such a manner that when the blocks are assembled, certain text appear first, to allow text to form a sequence for programmable code. This implementation avoids complex segmentations and classification operations that would otherwise have to be performed to determine the programming sequence.

Current programming tools can overwhelm users with complex interfaces and abstract syntax. In contrast, the exemplary system and method, with their jigsaw-puzzle-like-looking physical coding blocks, can provide a tangible, visual, and intuitive programming experience. The physical coding blocks are non-electronic, low-cost, and reproducible, making the exemplary system accessible and scalable for classroom use. Unlike current systems that require specialized hardware or technical expertise, the exemplary system and method can facilitate users with minimal prior experience to complete programming tasks with fewer errors and greater confidence.

By combining the accessibility of tangible components (e.g., physical coding blocks) with the flexibility of integration with software development environments, the exemplary system and method can address key limitations in beginner programming education, such as the lack of integration with coding environments or platforms, limited opportunities for continued learning, and barriers to collaboration and hands-on engagement. The exemplary system and method can foster collaboration, encourage experimentation, and support a smooth progression from novice to more advanced coding skills, while maintaining compatibility with educational platforms and tools (e.g., MakeCode).

In some embodiments, the exemplary system infers program logic based on the spatial arrangement of physical coding blocks. Each physical coding block contains printed text or symbols representing code elements (e.g., variables, functions, loops), and their relative positions (e.g., left to right, top to bottom) are used to determine execution order.

In an aspect, a kit is disclosed comprising: a plurality of physical coding blocks for a kit of programmable coding blocks having observable correspondence (e.g., shape, text, color, etc.) to coding blocks in a software development environment (e.g., MakeCode), including a first physical coding block having an observable correspondence to a first coding block in the software development environment, a second physical coding block having an observable correspondence to a second coding block in the software development environment, and a third physical coding block having an observable correspondence to a third coding block in the software development environment, wherein the first coding block in the software development environment and the first physical coding block has a first associated programming function, wherein the second coding block in the software development environment and the second physical coding block has a second associated programming function, wherein the third coding block in the software development environment and the third physical coding block has a third associated programming function, wherein the first physical coding block has a first shaped surface and a second shaped surface, wherein the second physical coding block has a third shaped surface configured to attachably and re-attachably assemble with the first shaped surface of the first physical coding block and the third physical coding block has a fourth shaped surface to attachably and re-attachably assemble with the second shaped surface of the first physical coding block, to form a coding block assembly, wherein the assembly combines the associated programming functions in a sequence having correspondence to a combined sequence of the first coding block, the second coding block, and the third coding block in the software development environment, and wherein an image acquired of the assembly of the first physical coding block with the second physical coding block and the third physical coding block is used to generate computer compilable or interpretable code in the software development environment having the programming functions in the sequence having correspondence to the combined sequence of the first coding block, the second coding block, and the third coding block, and wherein the compilable or interpretable code in the software development environment is compiled or interpreted to generate computer-readable instructions for execution on an electronic device (e.g., microcontroller).

In some embodiments, the image acquired of the assembly of the first physical coding block with the second physical coding block and the third physical coding block by an intermediate computing device is used to generate the computer compilable or interpretable code at the intermediate computing device to be imported into the software development environment for compiling.

In some embodiments, the image acquired of the assembly of the first physical coding block with the second physical coding block and the third physical coding block by an intermediate computing device is used to generate, at the intermediate computing device, computer-readable instructions for execution on the electronic device.

In some embodiments, the observable correspondence of each physical coding block to a respective coding block in the software development environment includes text, relative positioning, spatial arrangement, or a combination thereof representing a respective programming function in the software development environment.

In some embodiments, the generation of the compilable or interpretable code at the intermediate computing device comprises: generating, via an image recognition or image-to-text translation model (e.g., Google Vision), an instruction object/structure having the programming functions in a sequence having correspondence to the combined sequence of the first coding block, the second coding block, and the third coding block; and generating, via a processor, the compilable or interpretable code having the programming functions in the sequence having correspondence to the combined sequence, using the generated instruction object/structure, wherein the compilable or interpretable code is imported into the software development environment to be compiled or interpreted to generate the computer-readable instructions for execution on the electronic device.

In some embodiments, the generation of the computer-readable instructions at the intermediate computing device comprises: generating, via an image recognition or image-to-text translation model (e.g., Google Vision), an instruction object/structure having the programming functions in a sequence having correspondence to the combined sequence of the first coding block, the second coding block, and the third coding block; and generating, via a processor, the computer-readable instructions for execution on the electronic device, using the generated instruction object/structure.

In another aspect, a system is disclosed comprising: a kit including a plurality of physical coding blocks, each having an observable correspondence to a respective coding block in a software development environment (e.g., MakeCode), each respective coding block having an associated programming function; and an intermediate computing device including: a processor; and a memory having instructions stored thereon, wherein execution of the instructions causes the processor to: receive, via an interface, an image of a coding block assembly; generate, via an image recognition or image-to-text translation model (e.g., Google Vision), an instruction object/structure representing programming functions in a sequence having correspondence to a combined sequence of physical coding blocks in the assembly; and generate, using the generated instruction object/structure, compilable or interpretable code having the programming functions in the sequence, wherein the compilable or interpretable code is imported into the software development environment to be compiled or interpreted to generate computer-readable instructions for execution on an electronic device.

In some embodiments, the plurality of physical coding blocks comprises: a first physical coding block having an observable correspondence to a first coding block in the software development environment; a second physical coding block having an observable correspondence to a second coding block in the software development environment; and a third physical coding block having an observable correspondence to a third coding block in the software development environment.

In some embodiments, the first physical coding block has a first shaped surface and a second shaped surface; the second physical coding block has a third shaped surface configured to attachably and re-attachably assemble with the first shaped surface of the first physical coding block; and the third physical coding block has a fourth shaped surface configured to attachably and re-attachably assemble with the second shaped surface of the first physical coding block, to form the assembly, wherein the assembly combines associated programming functions in a sequence having correspondence to a combined sequence of the first, second, and third coding blocks in the software development environment.

In some embodiments, the execution of the instructions further causes the processor to: generate, via the processor, the computer-readable instructions for execution on the electronic device, using the generated instruction object/structure.

In some embodiments, the observable correspondence of each physical coding block to a respective coding block in the software development environment includes text, relative positioning, spatial arrangement, or a combination thereof representing a respective programming function in the software development environment.

In yet another aspect, a non-transitory computer-readable medium is disclosed having instructions stored thereon, wherein execution of the instructions by a processor causes the processor to: receive, via an interface, an image of a coding block assembly including a plurality of physical coding blocks, each having an observable correspondence to a respective coding block in a software development environment; generate, via an image recognition or image-to-text translation model, an instruction object/structure representing a sequence of programming functions having correspondence to a combined sequence of the physical coding blocks in the assembly; and generate, via the processor, compilable or interpretable code having the programming functions in the sequence having correspondence to the combined sequence of the physical coding blocks in the assembly, using the generated instruction object/structure, wherein the compilable or interpretable code is imported into the software development environment to be compiled or interpreted to generate computer-readable instructions for execution on an electronic device.

In some embodiments, the coding block assembly includes: a first physical coding block having an observable correspondence to a first coding block in the software development environment, the first coding block having a first associated programming function; a second physical coding block having an observable correspondence to a second coding block in the software development environment, the second coding block having a second associated programming function; and a third physical coding block having an observable correspondence to a third coding block in the software development environment, the third coding block having a third associated programming function.

In some embodiments, the first physical coding block has a first shaped surface and a second shaped surface; the second physical coding block has a third shaped surface configured to attachably and re-attachably assemble with the first shaped surface of the first physical coding block; and the third physical coding block has a fourth shaped surface configured to attachably and re-attachably assemble with the second shaped surface of the first physical coding block, to form the assembly, wherein the assembly combines associated programming functions in a sequence having correspondence to the combined sequence of the first, second, and third coding blocks in the software development environment.

In some embodiments, the execution of the instructions further causes the processor to: generate, via the processor, the computer-readable instructions for execution on the electronic device, using the generated instruction object/structure.

In some embodiments, the observable correspondence of each physical coding block to a respective coding block in the software development environment includes text, relative positioning, spatial arrangement, or a combination thereof representing a respective programming function in the software development environment.

### BRIEF DESCRIPTION OF DRAWINGS

FIGS. 1A-1C each shows an example system configured for tangible programming comprising physical tangible blocks, a software development environment, and an interface software to export programming encoded in the physical tangible blocks into the software development environment, in accordance with an illustrative embodiment.

FIGS. 2A-2C each shows an example method of operation for the exemplary system, in accordance with an illustrative embodiment.

FIGS. 3A-3D show an example plurality of physical coding blocks, an example operation flow of a computing device and interface thereon, and an example user interface, of the exemplary system, in accordance with an illustrative embodiment.

FIGS. 4A-4C show example procedures for building a combined sequence of virtual coding blocks in a software development environment, and an example physical block assembly representing a sequence of programming functions.

FIGS. 5A-5B shows a procedure of a 6-hour experiment, the toolkit provided in the experiment, and activities of the participating groups (e.g., groups 1-5).

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

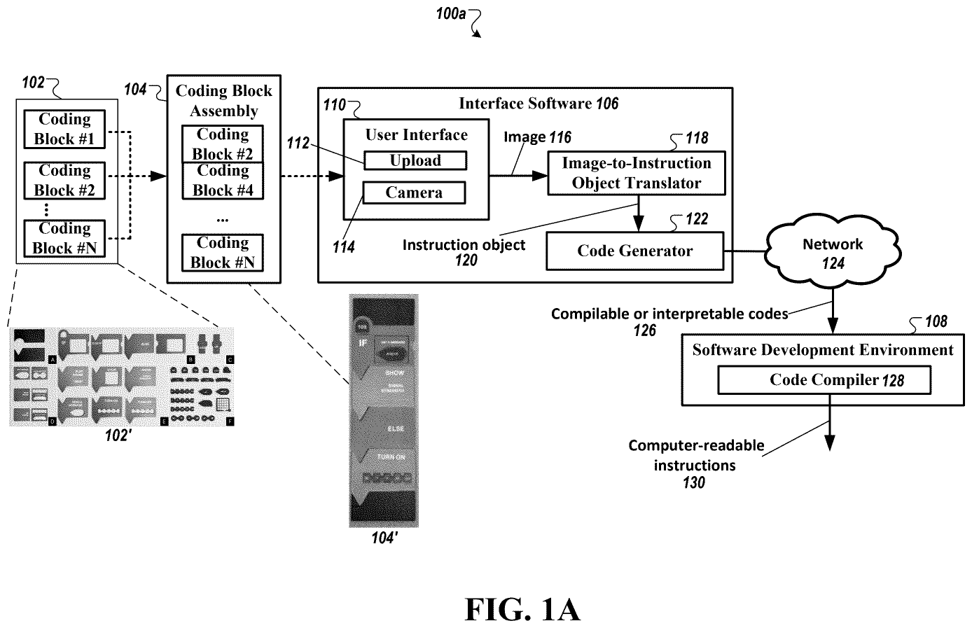

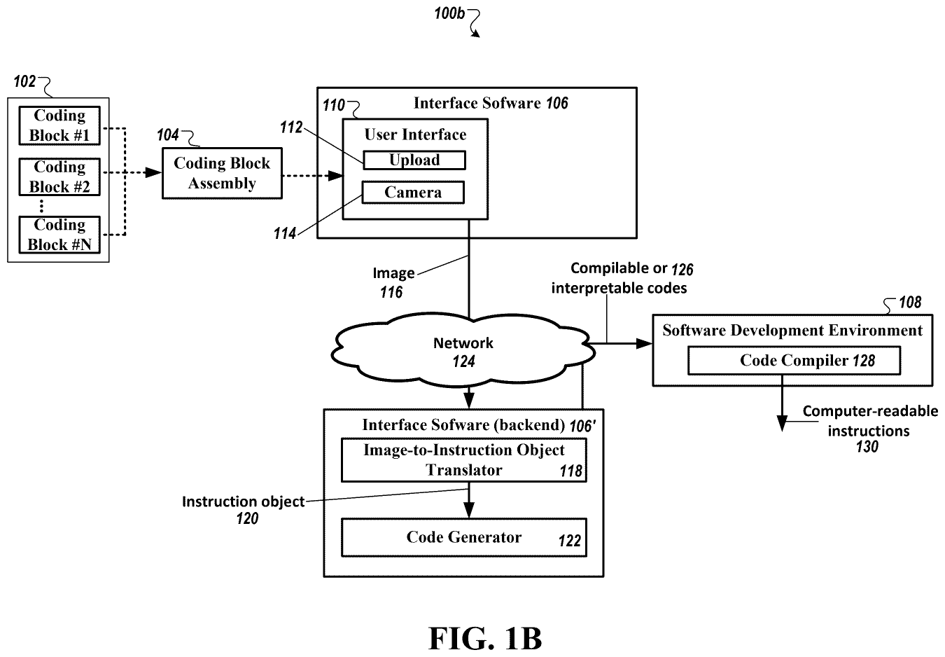

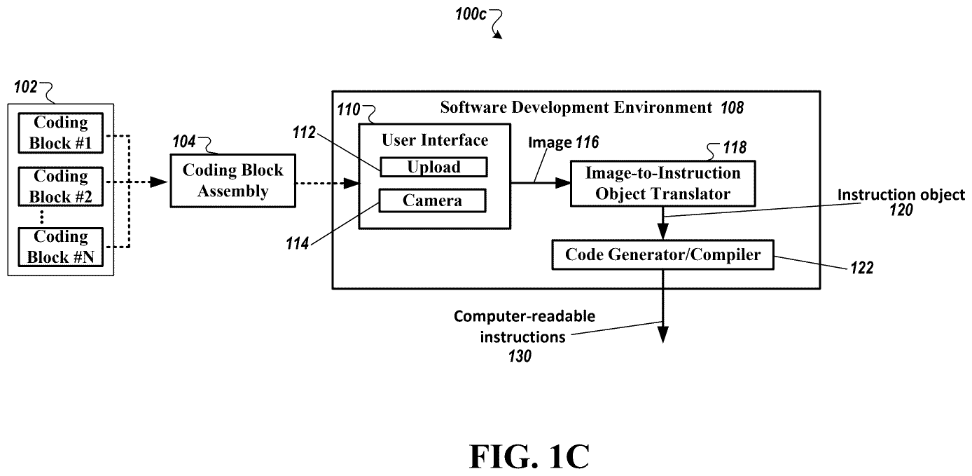

FIGS. 1A-1C each shows an example system 100 (shown as 100a, 100b, 100c) configured for tangible programming (e.g., programming or learning to program through interaction with physical objects) comprising physical tangible blocks 102 to be assembled into an assembly 104 operates with a software interface 106 that provides the assembly 104 as programming code for a software development environment 108. The interface software 106 is configured to take an image or video acquired of the assembly 104 and export the programming encoded in the physical tangible blocks 102 into the software development environment 108.

In the example shown in FIG. 1A, the set of physical coding blocks 102 (shown as “Coding Block #1,” “Coding Block #2,” . . . “Coding Block #N”) can be assembled as a coding block assembly 104 to which an image or video frame 116 of coding block assembly 104 can be acquired by the interface software 106. The interface software 106 is configured to recognize and translate information (e.g., programming function sequence) represented in the coding block assembly 104 (shown as 104′) of the physical coding blocks into an instruction object 120 (e.g., text, metadata, etc.) (also referred to as instruction structure). The interface software 106 then generates, using the instruction object 120 (see FIG. 1C) or compilable/interpretable codes 126 (e.g., C/C++, etc.) (see FIGS. 1A-1B) derived therefrom, computer-readable instructions 130 (e.g., .exe, assembly, etc.) that can be used to program an electronic device, in accordance with an illustrative embodiment.

In the examples shown in FIGS. 1A-1C, the interface software 106 is configured to translate, via an image-to-instruction object translator 118, information (e.g., programming function sequence) formed by a coding block assembly 104 of the coding blocks into the instruction object 120. The interface software 106 includes a code generator 122 configured to generate the compilable or interpretable codes 126 using the instruction object 120 that can then be exported to the software development environment 108.

In FIG. 1A, the image-to-instruction objection translator 118 and code generator 122 are implemented in a standalone interface software 106 executed in a user computing device or through a web interface. In FIG. 1B, the image-to-instruction object translator 118 and code generator 122 are located on a cloud infrastructure (e.g., Amazon Web Services, etc.) implemented as a backend 106′ of the interface software. In FIG. 1C, the image-to-instruction object translator 118 and code generator 122 are implemented as modules in the software development environment 108.

Physical Coding Blocks (102) and Coding Block Assembly (104). The physical coding blocks 102 are each tangible coding elements that can be attachably and re-attachably coupled to one another to form a code block that can be translated into computer-readable instructions. Certain coding elements are base coding elements that connect to one another to form a sequence. Certain coding elements are data elements that can be embedded into the base coding elements to define sub-operations defined by the base coding elements. Each physical coding block 102 has an observable correspondence to a coding block (referred to as a virtual coding block) in the software development environment 108 (e.g., Microsoft MakeCode platform), e.g., in terms of text, relative positioning, spatial arrangement, or a combination thereof, representing the same or similar associated programming function. The correspondence is sufficient to allow a user to identify some similarity or correspondence between the physical object and the virtual programming counterpart. The physical object can be designed to be physically safer and more appropriate for manufacturing (e.g., less tolerance, more rounded corners, simpler shapes).

Software Interface (106). The software interface 106 includes a user interface 110, an image-to-instruction object translator 118, and a code generator 122.

The user interface 110 is a software module configured to receive or capture images or video frames 116 of the assembly 104. In some embodiments, the user interface includes an upload component 112 (e.g., button, upload drag/drop) for a user to upload an image (e.g., of the assembly 104). In some embodiments, the user interface 110 includes a camera or video component 114 configured to operate a local camera for the computing device executing the software interface. The user interface 110 can store the acquired images or video frames for later retrieval. In some embodiments, the user interface 110 is configured to push the acquired image to other modules of the software interface 106, and (ii) transmit, via direct communication or a network 124, the images 116 to the image-to-instruction object translator 118.

The image-to-instruction object translator 110 is configured to generate the instruction object 120 representing the programming functions in the image or video 116 in a sequence corresponding to the combined assembly 104 of the coding blocks 102. In some embodiments, the image-to-instruction object translator 118 is operatively coupled to the user interface 110 and is co-located on the same computing device (e.g., FIG. 1A). In some embodiments, the image-to-instruction object translator 118 is separately located on an external computing device (e.g., in the cloud infrastructure (e.g., FIG. 1)). In some embodiments, the image-to-instruction object translator 118 is co-located with the software development environment as a module natively implemented therein (e.g., FIG. 1C).

Software Development Environment (108). MakeCodeTangible (MCT), and other like platforms, is an educational system that supports coding education via tangible programming through visual elements for learning basic and advanced coding concepts in a visual space. By integrating tangible programming of a software development environment like MakeCode with a specific design space for early education, the exemplary system addresses the entry barriers in physical computing education and provides a hands-on learning environment. The software development environment 108 (e.g., Microsoft MakeCode platform) is preferably a standalone online platform. The environment 108 is configured to (i) receive, via the network 124, compilable or interpretable codes 126 (e.g., C/C++, etc.) from the code generator 122 and (ii) generate, via the code compiler 128, computer-readable instructions 130 (e.g., .exe, assembly, etc.) for execution on the electronic device (e.g., microcontroller, PC), using the compilable or interpretable codes 126.

### Example Method

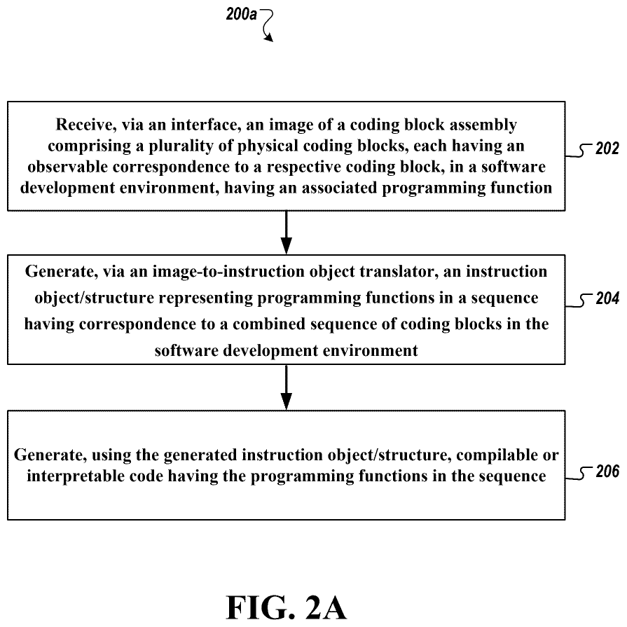

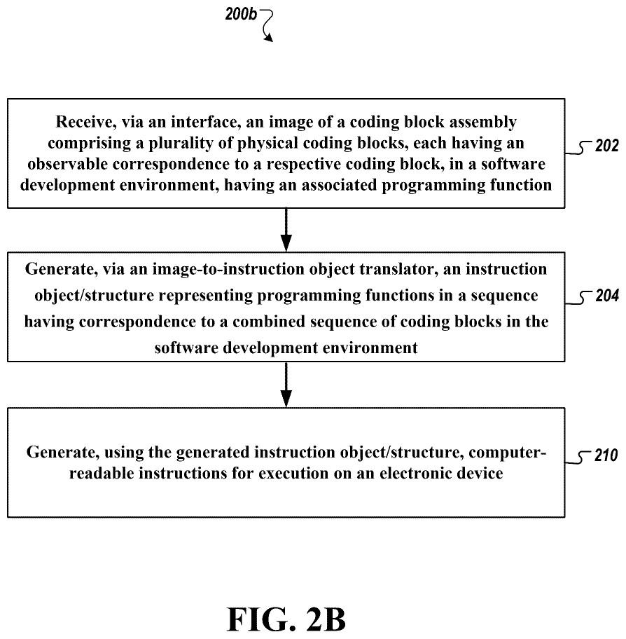

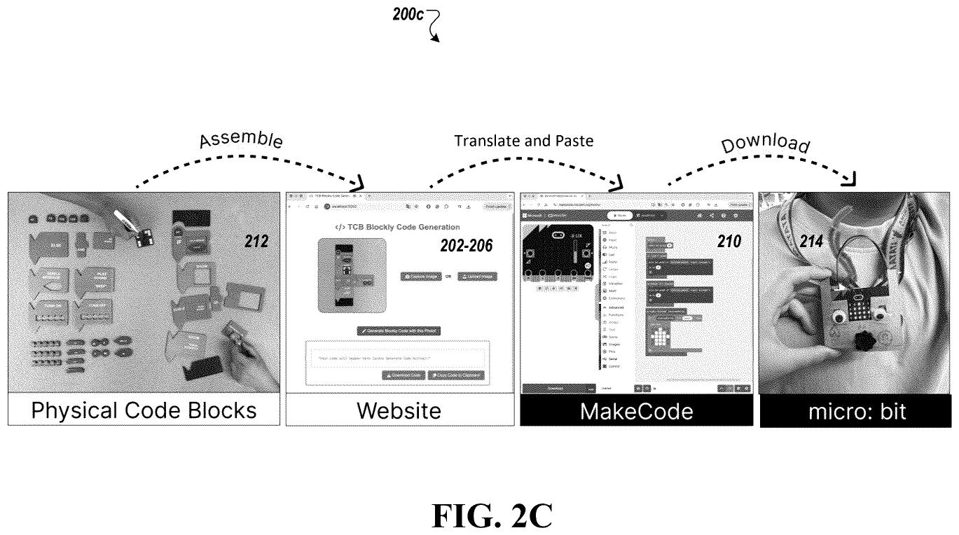

FIGS. 2A-2C each shows an example method 200 (shown as 200a-200c) of operation for the exemplary system, in accordance with an illustrative embodiment.

In the examples shown in FIGS. 2A-2B, the method 200a-200b includes receiving (202), via an interface (e.g., web-based interface), an image of a coding block assembly comprising a plurality of physical coding blocks, each having an observable correspondence to a virtual coding block, in a software development environment, having an associated programming function. Method 200a-200b includes generating (204), via an image-to-instruction object translator (e.g., Google Vision), an instruction object (e.g., text, metadata, etc.) (also referred to as an instruction structure) representing programming functions in a sequence corresponding to a combined sequence of virtual coding blocks in the software environment. The combined sequence of virtual coding blocks is equivalent to the combined sequence of physical coding blocks in the coding block assembly.

In FIG. 2A, method 200a includes generating (206), using the generated instruction object, compilable or interpretable codes having the programming functions in the sequence. The compilable or interpretable codes can be imported into the software development environment to be compiled or interpreted to generate computer-readable instructions for execution on an electronic device.

In FIG. 2B, method 200b includes generating (210), using the generated instruction object, computer-readable instructions (e.g., .exe, assembly) for execution on an electronic device, without relying on compilable or interpretable codes.

Each physical coding block, in the plurality of physical coding blocks, can have an observable correspondence (e.g., shape, text, color, etc.) to a coding block (referred to as a virtual coding block) in the software development environment (e.g., Microsoft MakeCode platform). The observable correspondence of each physical coding block to a respective virtual coding block (in the environment) can include text, shape, color, or a combination thereof, representing the same associated programming function.

Each physical coding block can have one or more shaped surfaces configured to attachably or re-attachably assemble with one or more shaped surfaces of other physical coding blocks. When two or more physical coding blocks are attachably or re-attachably assembled, via one or more shaped surfaces, into a coding block assembly, the assembly can combine the associated programming functions (of the two or more physical coding blocks) in a sequence corresponding to a combined sequence of the equivalent virtual coding blocks in the software development environment.

In FIG. 2C, the method 200c includes assembling (212) a plurality of physical coding blocks into one or more physical block assemblies. Method 200c further includes downloading (214) the computer-readable instructions onto an electronic device (e.g., Micro:bit controller) and executing them thereon to operate the electronic device.

### Example Physical Coding Blocks and Block Assembly

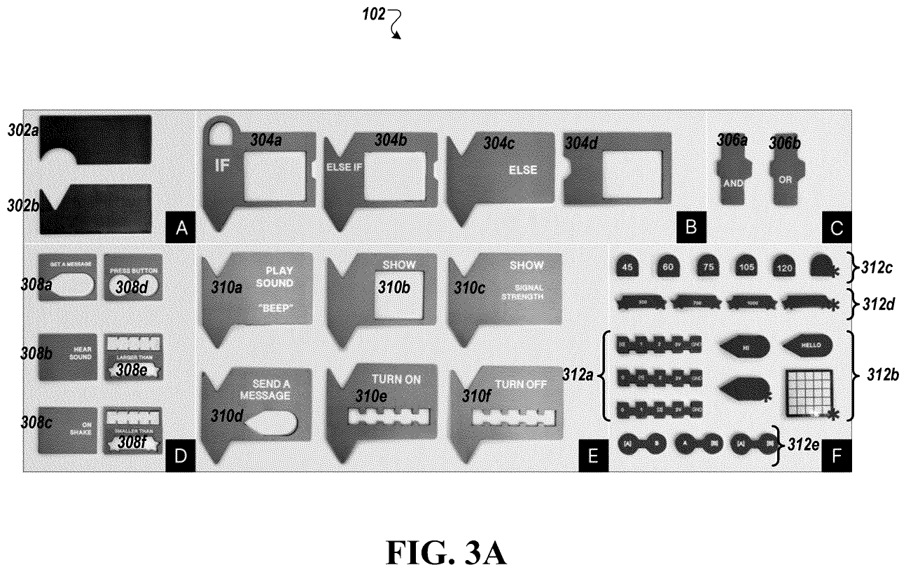

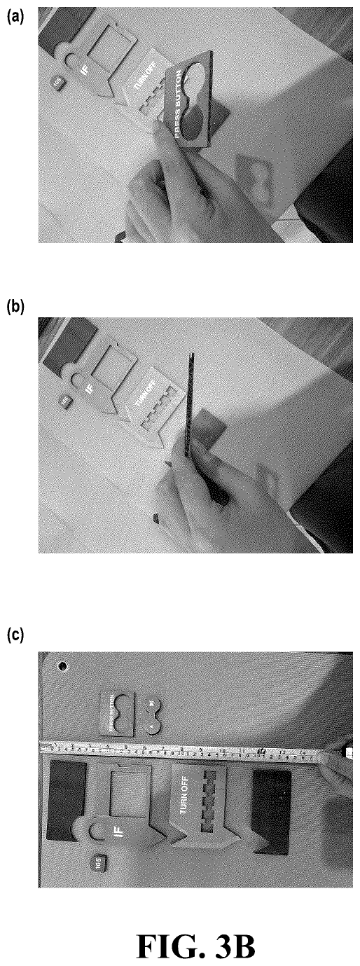

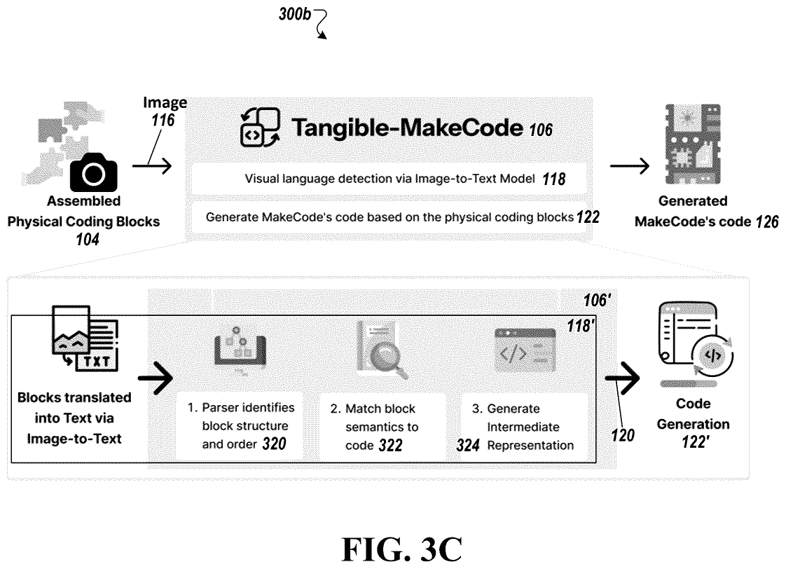

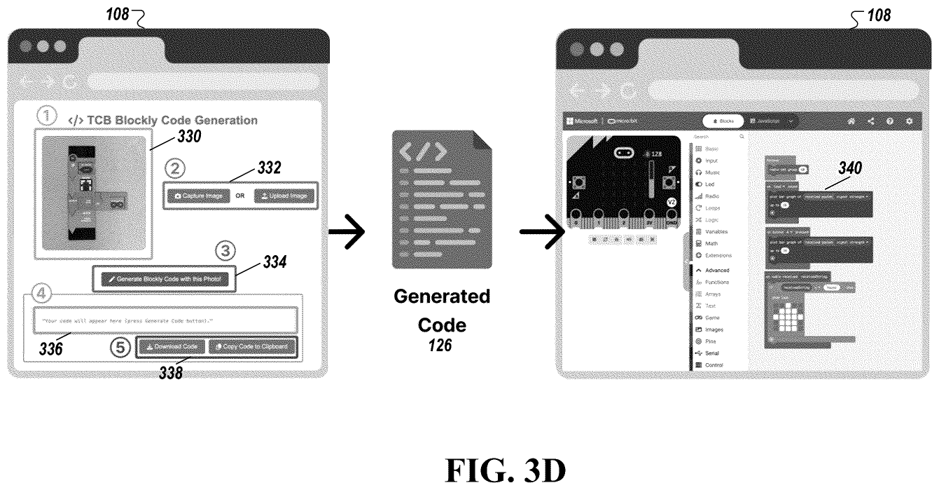

Physical Coding Blocks. FIGS. 3A-3B each shows a set of physical coding blocks, where each physical coding block (i) has a shape, text, and color, and (ii) is configured to represent an input action value, an output action value, a variable, or a compiler value.

In the example shown in FIG. 3A, the plurality of physical coding blocks 102, in the exemplary system, is configured to represent compiler values, input action values, output action values, and variables. Specifically, in subpanel (a), blocks 302a-302b (referred to as compiler blocks) are configured to represent the boundary, defining the start and end of each block assembly. The blocks 302a-302b frame the sequence of actions.

In subpanels (b)-(d), blocks 304-308 are associated with input actions. In subpanel (b), blocks 304a-304c (referred to as conditional blocks) are configured to represent conditional logic, including “if”, “else if”, and “else” statements, and blank block 304d is configured to connect other blocks with conditional-logic blocks. In subpanel (c), blocks 306a-306b (referred to as logical operator blocks) are configured to represent logical operators, including “and” and “or”. In subpanel (d), blocks 308a-308f (referred to as input blocks) are configured to represent input triggers, including “get a message”, “press button”, “hear sound”, “on shake”, “larger than”, and “smaller than”, for analog pin readings.

In subpanel (e), blocks 310a-310f (referred to as output blocks) are configured to represent output actions, such as “play sound ‘beep’”, “show LED (emoticon or text)”, “turn on/off connected devices”, “send a message”, and “show signal strength”.

In subpanel (f), blocks 312a-312d (referred to as variable blocks) are configured to represent variables, such as pin options 312a, pin reading values 312b, radio channel numbers 312c, and more (e.g., 312d-312e). To reduce the learning curve, buttons 312d having predefined options (e.g., “300”, “700”, “1000”) are provided with blank spaces for students to input custom values.

In some embodiments, the physical coding blocks are displayed on a table (e.g., of 24×18 inches), and each block is easily grabbed and interacted with. The physical coding blocks can be in a range of handheld sizes, from finger-sized blocks (e.g., variable blocks) to palm-sized blocks (e.g., conditional blocks), which can provide ease of handling and play. The physical coding blocks can also be scalable, facilitating larger or smaller versions to be created without affecting their functionality.

Texts on the physical coding blocks should be easily understood by children. For example, the command “digital write pin0 ‘0’ or ‘1’” on the online platform (e.g., Microsoft MakeCode platform) may be simplified to “turn on/turn off”, and “play tone middle C for 1 beat” may be simplified to “play sound ‘beep’” on the physical physical coding blocks. However, pin numbers (0, 1, 2, 3, 3V, GND) and values can remain unchanged to avoid confusion when connecting additional devices to a microcontroller coupled with the online platform (e.g., Micro:bit connected to Microsoft MakeCode platform), as these pins are already labeled (0, 1, 2, 3, 3V, GND) on the microcontroller.

The physical coding blocks can include dedicated pin blocks that facilitate the connection of external inputs and outputs, from external devices (e.g., sensors, motors, etc.), to the microcontroller. Each pin, in a pin block on a physical coding block, can directly correspond to a physical pin of the microcontroller. For example, to connect an external device to pin 0 of the microcontroller, the external device should be connected to pin 0 of a pin block (on a physical coding block) labeled with (0, 1, 2, 3V, GND). This direct correspondence can facilitate users to connect external devices to the microcontroller, by matching the labeled pin on a pin block to the correct pin on the microcontroller. Additionally, variable blocks and input blocks are provided for analog readings, reducing the need to understand the meaning of values before using them. By having hands-on experience, for example, using the “larger than” input block and the “300” variable block for analog value readings, the user can grasp the meaning of the value.

In the example shown in FIG. 3B, subpanels (a)-(c) show that the physical coding blocks are made of cardboard and have small sizes and shapes so that users can easily interact with them using their hands.

Coding Block Assembly. In some embodiments, a physical coding block assembly is created based on two rules: (1) start and end with a compiler block, and (2) avoid blank spaces. The additional learning required for users can be minimized by keeping the requirements simple. For example, some blocks, such as conditional-logic blocks (see 304, FIG. 3A), can have holes that may be filled with other blocks. Although compiler blocks (see 302, FIG. 3A) are not required for successful conversion of the block assembly on a software development environment (e.g., Microsoft MakeCode platform) (see 116, FIGS. 1A-1C), they can help users understand the beginning and end points of the code, reinforcing the flow and structure of an assembled coding program on the online platform.

### Example Web-Based Interface Software

The exemplary system employs an interface software 106 having a web-based interface (see 110, FIGS. 1A-1C) configured to translate an assembly of physical coding blocks (see 104, FIGS. 1A-1C) into compilable or interpretable codes (see 126, FIGS. 1A-1C) for a software development environment (e.g., MakeCode platform) (see 108, FIGS. 1A-1C). Table 1 shows example configurations and operations of the web-based interface software.

TABLE 1

| Operation Step | Description |
|---|---|
| Block assembly | The interface software can receive images of a physical block assembly |
| image reception | via (i) live camera capture using a webcam (see 114, FIGS. 1A-1C) or |
| | (ii) image upload (see 112, FIGS. 1A-1C) to the interface. |
| Text recognition | The interface software can extract the text on the physical coding blocks |
| | in the block assembly, using a text-to-image translator (e.g., Google |
| | Vision API) (see 118, FIGS. 1A-1C). The extracted text can be used to |
| | determine an instruction object (e.g., in JavaScript format) (see 120, |
| | FIGS. 1A-1C), representing programming functions in a sequence |
| | corresponding to a combined sequence of virtual coding blocks in the |
| | software development environment (e.g., MakeCode). |
| Computer-readable | The interface software can generate compilable or interpretable codes |
| instructions | (e.g., JavaScript) in the software development environment, using the |
| generation | instruction object. |
| Online platform | The interface software can copy and paste the compilable or |
| integration | interpretable codes onto the software development environment, where |
| | the compilable or interpretable codes are compiled to generate |
| | computer-readable instructions (see 130, FIGS. 1A-1C) for a |
| | microcontroller (e.g., Micro:bit). |

FIG. 3C shows an example operation flow 300c, of the interface software (shown as Tangible-MakeCode 106, 106′), for translating physical coding blocks 104 into compilable or interpretable codes 126 on a software development environment (e.g., MakeCode). As shown, the interface software 106 can receive, on a frontend interface (e.g., built with HTML, CSS, and/or JavaScript), images 116 of a physical block assembly 104 (e.g., via camera capture or website upload by users). Then, interface software 106 can (i) extract, in a backend (e.g., hosted on a server), texts (e.g., programming functions on physical coding blocks) from the images 116 of the block assembly 104 using an image-to-text translator 118 (shown as 118′) (e.g., Google Vision), and (ii) generate, via code generation 122 (shown as 122′) (in the backend), compilable or interpretable codes 126 using an instruction object 120 (shown as intermediate representation) built from the extracted texts. The compilable or interpretable codes 126 can be compiled on the software development environment to generate computer-readable instructions for execution on a microcontroller (e.g., Micro:bit).

The translator 118 (shown as 118′) is configured to (i) determine (320), via a text parser, order and structure (e.g., JavaScript-formatted) of the instruction object 126 representing programming functions in a sequence corresponding to a combined sequence of virtual coding blocks on the software development environment, using the extracted texts, and (ii) generate (122′) compilable or interpretable codes 126 using the instruction object 120, after aligning/matching (322) semantics of the instruction object 120 with the compilable or interpretable codes 126 and generating (324) the instruction object 120. The compilable or interpretable codes 126 can be later compiled, in the software development environment, into computer-readable instructions for the microcontroller (e.g., Micro:bit).

FIG. 3D shows an example user interface 110 of the interface software 106 configured to generate compilable or interpretable code 126 (shown as generated code) for a software development environment 108 (e.g., MakeCode). As shown, the interface 110 comprises (i) a display window 330 configured to show an image of a physical block assembly, (ii) an image capture/upload module 332 configured to receive the image of the physical block assembly, uploaded by the user or captured using a live camera (e.g., webcam), (iii) a button 334 configured to initiate the generation of compilable or interpretable code 126 (e.g., in javascript format) using the image of the physical block assembly, (iv) a code display window 336 configured to show the code 126, and (v) download/copy code module 338 configured to download or copy the code 126 into a storage or clipboard of the interface software 106. The compilable or interpretable code 126 can then be imported into the software development environment 108 to be compiled into computer-readable instructions for execution on an electronic device (e.g., Micro:bit microcontroller).

### Procedures to Build a Combined Sequence of Virtual Blocks

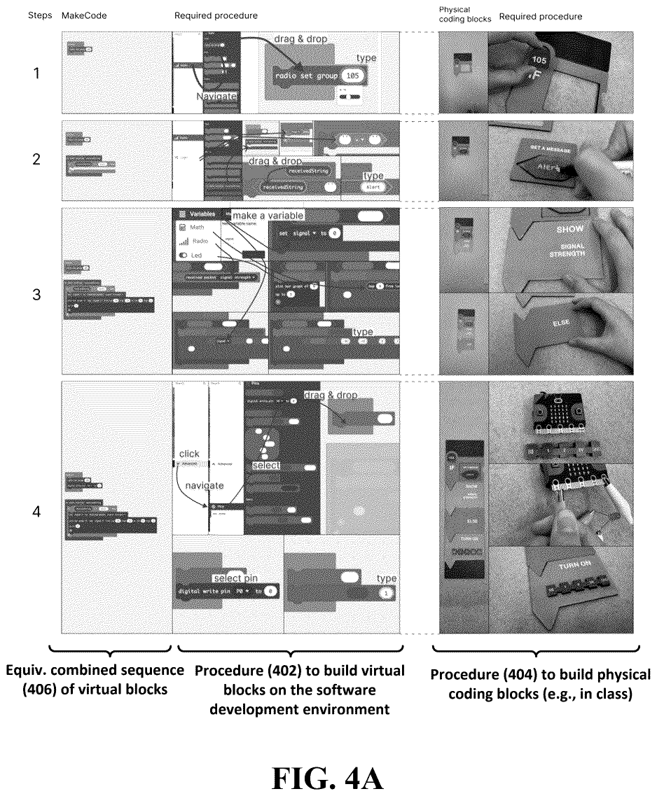

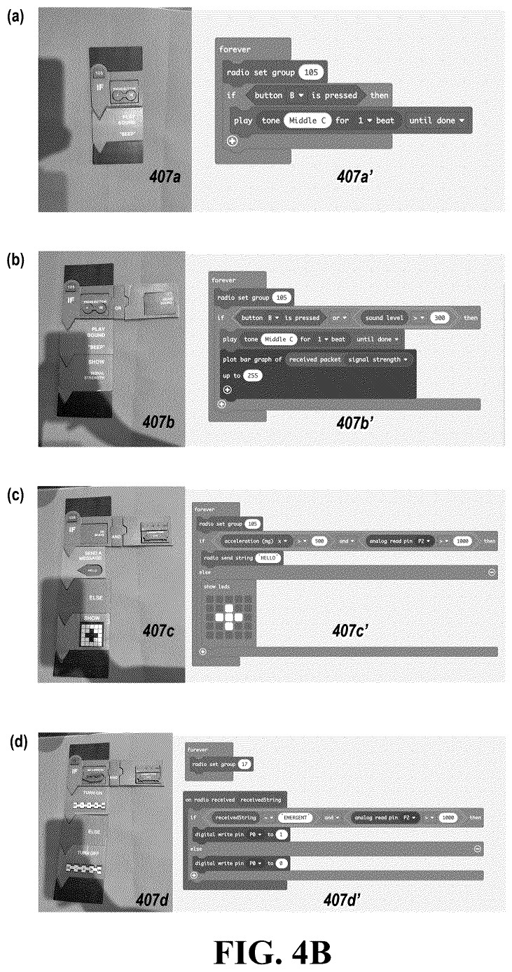

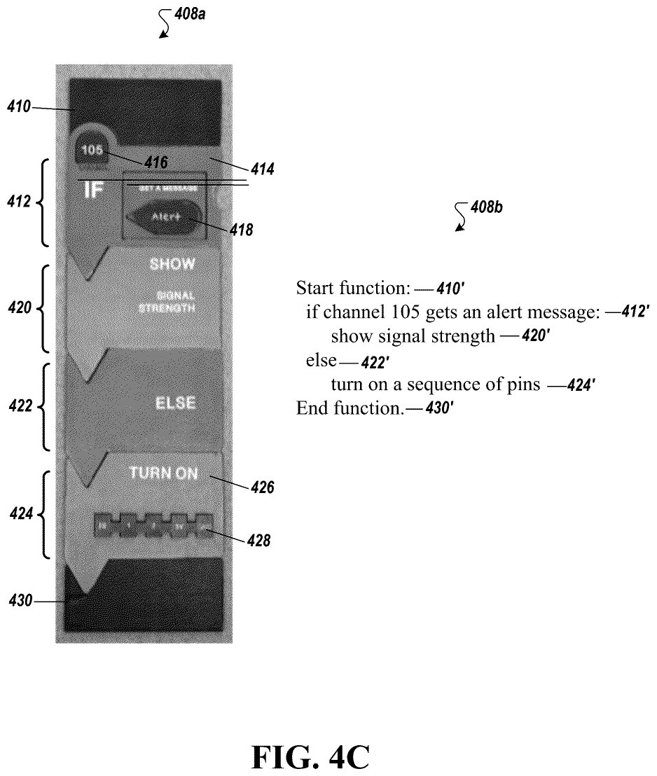

FIG. 4A shows example procedures (e.g., 402, 404), each with 4 steps, for building a combined sequence 406 (i.e., assembly) of virtual coding blocks in a software development environment. Procedure 402 shows online actions (e.g., online click, drag, drop, type) of building the combined sequence 406 directly in the software development environment. Procedure 404 shows in-person actions (e.g., physical manipulation) of building a physical block assembly in real-world settings (e.g., class), which can be translated into the combined sequence 406, using the exemplary system (see 100a-100c, FIGS. 1A-1C), in the same environment.

As shown, at each step 1-4, the procedure 404 requires fewer actions than the procedure 402. Compared to the virtual blocks, in procedure 402, and virtual assembly thereof, physical coding blocks, in procedure 404, and physical assembly thereof, are simpler-looking with precise texts (e.g., letters, numbers, etc.) on the surface, and easier to assemble with other blocks based on simplified and attachable shaped surfaces of each physical block.

FIG. 4B shows example assemblies of physical coding blocks 407a-407d having correspondence to assemblies of virtual coding blocks 407a′-407d′, respectively, in a software development environment (e.g., MakeCode).

FIG. 4C shows an example physical block assembly 408a configured to represent a programming function 408b. As shown, the assembly 408a is formed of small assemblies (e.g., 410, 412, 420, 422, 424, 430), where each small assembly is further formed of physical blocks (e.g., 410, 414, 416, 418, 420, 422, 426, 428, 430). Each small assembly is configured to represent a line of code (e.g., 410′, 412′, 420′, 422′, 424′, and 430′) in the function 408b.

In FIG. 4C, the small assembly 410, formed of only block 410 (compiler block), represents line 410′ to define the start of the function 408b. The small assembly 412, formed of blocks 414 (conditional block), 416 (variable block), and 418 (variable block), represents line 412′ to check if channel 105 gets an alert message for receiving a signal. The small assembly 420, formed of only block 420 (output block), represents line 420′ to show/display the signal strength of the received signal, if the channel 105 receives the signal. The small assembly 422, formed of only block 422 (conditional block), represents line 422′ to check if the channel 105 does not get an alert message. The small assembly 424, formed of block 426 (e.g., output block) and block 428 (e.g., variable block), represents line 424′ to turn on a sequence of pins (e.g., 3V, GND, etc.), if the channel 105 does not get an alert message or a signal. The small assembly 430, formed of only block 430 (compiler block), represents line 430′ to define the end of the function 408b.

The physical block assembly 408a is one of many block assemblies that can be created by various combinations of physical coding blocks. The physical coding blocks, if assembled into code functions that adhere to programming language standards (e.g., C/C++, Java, etc.), can form a physical block assembly (e.g., 408a) that represents equivalent code functions in a form of compilable/interpretable code (see 128, FIGS. 1A-1C) or computer-readable instructions (see 128, FIGS. 1A-1C).

Position-based encoding. In some embodiments, the translation by the interface (e.g., 106) can be performed using design elements encoded into the physical block, e.g., text-only. In such elements, the text in the physical blocks may be imprinted on the blocks in such a manner that when the blocks are assembled, certain text appears first, to allow text to form a sequence for programmable code. This implementation avoids complex segmentations and classification operations that would otherwise have to be performed to determine the programming sequence.

In some embodiments, the exemplary system infers program logic based on the spatial arrangement of physical coding blocks. Each physical coding block contains printed text or symbols representing code elements (e.g., variables, functions, loops), and their relative positions (e.g., left to right, top to bottom) are used to determine execution order. A camera can then capture an assembly of the coding blocks, and an image processing algorithm (see 118, FIGS. 1A-1C) can then identify block boundaries and read the imprinted text. Because the physical coding blocks are configured with consistent formatting and alignment cues, the exemplary system can parse the programming sequence without the need for embedded electronics or fiducial markers. This method can simplify the hardware requirements and enhance accessibility, allowing users to prototype code using low-cost materials like paper and cardboard.

### Example Artificial Intelligence (AI) and Machine Learning (ML) Models

Machine Learning. In addition to the image-to-instruction object translation described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptrons (MLPs).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

A study was conducted to develop and evaluate an experimental system (also referred to as “Tangible-MakeCode”) for teaching users, via tangible programming, how to program a device (e.g., Micro:bit microcontroller), as described in relation to FIGS. 1-3.

Experiment Procedure. The study recruited 21 participants aged 12-14, of whom 10 were males and 11 were females, to evaluate the experimental system in a 6-hour experiment. To evaluate the experimental system, the study targeted 3 aspects: (1) engaging beginners, (2) fostering collaborative learning, and (3) promoting continued learning. Of the participants, 10 had some prior coding experience with Scratch or Python; however, only 2 were identified as “experienced,” while the rest had minimal experience. Nearly all participants had no prior exposure to the tangible programming platforms (e.g., MakeCode/Micro:bit) or physical computing.

The experiment occurred in a studio-based classroom with six large tables for team projects. Participants were organized into five groups of 4 or 5 based on their seating arrangements. Each table was equipped with stationary cameras to record video footage of participant engagement, track student progression, and capture images of the physical coding block assemblies and corresponding executable/compilable computer-readable instructions (e.g., MakeCode outputs) for data collection. Additionally, the study used a roaming camera to record supplementary video footage.

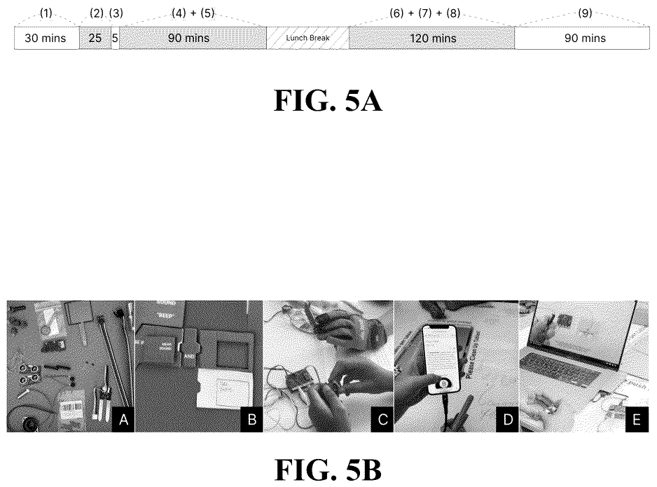

FIG. 5A shows the procedure of the 6-hour experiment. As shown, the experiment had 9 phases/sessions: (1) 30-minute pre-survey: upon arrival, participants sat down and completed a pre-survey about their prior coding experiences; (2) 25-minute introduction: participants were engaged in envisioning their own wireless communication devices, aligning with a theme of the experiment; (3) 5-minute system overview: an overview of the experimental system was provided; (4) 30-minute team-based ideation: participants brainstormed and sketched wireless communication devices for their team projects; (5) 60-minute physical coding blocks exploration: participants explored the physical coding blocks while continuing their ideation, specifically focusing on interaction design; (6) 5-minute overview of the web-based interface: an overview of the web-based interface (of the experimental system), external sensors, and actuators (see subpanel (a), FIG. 5B) were provided; (7) 25-minute exploration with the experimental system: participants explored the experimental system by assembling physical coding blocks, generating corresponding instructions/code using the web interface, and comparing the block assemblies with the generated instructions/code; (8) 90-minute development phase: groups iterated on developing interactive elements for their envisioned wireless communication devices; and (9) 90-minute post-survey and interviews: the participants completed a post-survey and interviews at the end of the experiment.

Data Analysis. The study employed a qualitative approach to evaluate participants' engagement, collaboration, and motivation to continue exploring coding. Additionally, the study analyzed the devices they created using the experimental system, focusing on their codes, their coding processes, and the challenges they faced. The analysis encompassed video observations from stationary and roaming footage, image analysis to monitor project development, and thematic analysis of the semi-structured interviews. The study also used a pre-survey to collect demographic data and prior coding experience, and a post-survey to gather feedback and suggestions from the participants for future improvements to the experimental system.

The study used a thematic coding approach for analyzing video and interview data, developing an initial codebook informed by research questions and experiment session logs. This codebook was refined as the analysis evolved. The thematic analysis focused on 3 areas: engagement, collaboration, and project development. The engagement theme explored how participants interacted with the coding environment, their level of sustained attention during activities, and their enthusiasm for the tasks. The study examined verbal and non-verbal cues to assess participants' engagement throughout the experiment sessions by noting moments of active participation, excitement, and concentration.

The collaboration theme explored how beginners with little to no prior coding experience could work together and contribute to the projects, including examining (i) their interaction with the experimental system, (ii) their role within group dynamics, and (iii) the extent of their involvement in decision-making and problem-solving processes.

The project development theme was centered on understanding how participants approached the interaction design with the experimental system and developed code for their projects. The study analyzed their problem-solving process and how they iterated on their project development.

Evaluation Results and Findings. The study presented the highlights related to themes of participant engagement, collaboration, and project development with the experimental system, supplemented by pre- and post-survey results.

FIG. 5B shows a toolkit provided to the participants, and activities of groups (e.g., groups 2-5) during the 6-hour experiment. In subpanel (a), the toolkit had proximity sensors, light sensors, force sensors, potentiometers, LEDs, servo motors, and buzzers. In subpanel (b), group 5 created a “take a picture” block using a sticky note because the available blocks were too limited for their idea. In subpanel (c), group 4 tested their code with the Micro:bit microcontroller and a servo motor to ensure the launch action was working. In subpanel (d), group 2 researched the Magic 8 Ball concept to improve its implementation with the experimental system. In subpanel (e), group 3 used YouTube to learn how to integrate a proximity sensor into the Micro:bit microcontroller, demonstrating their motivation for continued learning beyond the experimental system.

In the study, participants showed sustained attention to project development and enthusiasm throughout the experiment sessions. A participant from group 4, with no prior coding experience, explained that the physical coding blocks made it easier to understand the coding process by breaking it down into manageable steps, highlighting how the experimental system empowered the participants in their coding activities. However, participants from groups 1 and 5, with no prior experience with physical coding, initially found it more stressful due to the fear of having to do something they did not understand. Despite this, after hands-on experience with Micro:bit and their code, they described the experience as more rewarding, providing a sense of accomplishment and increasing confidence in their projects.

There were also moments when participants' engagement dropped due to the limitations of the available blocks. For example, in groups 3 and 5, participants lost focus when they realized the types of physical coding blocks were limited to creating code only for a predefined functionality (see subpanel (b), FIG. 5B). Specifically, group 3 wanted to adjust the volume of sound output, but the experimental system did not include coding blocks for this adjustment. Some participants, particularly those with prior coding experience, noted that text-based programming on a laptop would allow for a faster iteration and testing cycle. Overall, while the experimental system engaged participants and helped them maintain focus, especially among beginners, there is room for improvement to expand the functionality and better support participants with varying levels of coding experience.

A notable outcome was the active participation of beginners in team activities. Participants, especially beginners, actively explored interaction design ideas and development phases using the physical coding blocks. In groups 2 and 4, participants without coding experience volunteered to demonstrate and explain their projects during interviews. For example, a beginner-level participant from group 2 first asked team members questions about code functions (because he had no coding experience), then confirmed his understanding using physical coding blocks and Micro:bit, sought clarification, and contributed to group discussions of the project. An experienced member from group 4 noted that explaining physical coding blocks to beginner-level peers was easier than explaining software-based code, showing that the experimental system simplified coding concepts for beginners through physical, hands-on interactions. In group 5, where there were four experienced participants and one beginner, the beginner initially participated less actively. However, as the project progressed, particularly during the idea development phase with physical coding blocks, the beginner became highly engaged and took on a leadership role, guiding the project among team members. This transformation suggests that beginners gained confidence as they engaged with the experimental system, developing their skills throughout the activity. In group 3, where none of the team members had prior coding experience, participation levels were evenly distributed. These observations illustrate how the experimental system empowered beginners to build confidence in a collaborative learning environment, while facilitating experienced team members to support them through simplified, hands-on coding interactions. The experimental system also engaged all participants, regardless of their prior coding experience.

5 groups conceptualized and developed various unique projects with diverse interaction designs. Group compositions were diverse, with some teams having only members with no prior coding experience, while others included members with experience in Scratch or Python, though not specifically in physical coding or the MakeCode platform. Despite these differences, there was no variation in the complexity of their project ideas.

Table 2 summarizes the project outcomes for the groups in the study. Group 1 developed an earthquake detection system that alerted people through sound. Group 2 developed a ‘Magic 8 Ball,’ which provided random answers such as ‘No,’ ‘Maybe,’ or ‘Yes’ when shaken. Group 3 developed a home-security device that detected vibrations on a door. Group 4 developed a Spider-Man-inspired glove to launch an object upon receiving a signal. Group 5 developed a device for visually impaired individuals that provided audio feedback when an object was nearby, although it did not incorporate wireless communication. The variety of these projects illustrated the capacity of the experimental system, enabling a wide range of creative outcomes.

TABLE 2

| Group | Project Idea | System Description |
|---|---|---|
| #1 | An earthquake detection system | On channel 45, Transmitter: When a shake was |
| | that alerted people with sound. | detected, the transmitter turned on pin 0 (LED), |
| | | displayed the signal strength, sent a ‘hello’ message, |
| | | and then turned off pin 0 (LED). |
| | | Receiver: Upon receiving the ‘hello’ message, the |
| | | receiver played a ‘beep’ sound. |
| #2 | A ‘Magic 8 Ball’ that gave | On channel 120, Transmitter: When a shake was |
| | random answers, e.g., “Yes”, | detected, the transmitter sent a random message: “1” |
| | “No”, or “Maybe”, when shaken. | for ‘yes', “2” for ‘maybe’, or “3” for ‘no’, and |
| | | displayed a heart shape on the LED. If button ‘A’ |
| | | was pressed, the screen was cleared. |
| | | Receiver: Upon receiving a message (1, 2, or 3), |
| | | the receiver played a “beep” sound and displayed |
| | | ‘Y’ for yes, ‘M’ for maybe, or ‘N’ for no. |
| #3 | A home-security device that | On channel 75, Transmitter: When a shake was |
| | detected door vibrations to | detected, the transmitter sent a message: “alert”. |
| | alerted people and prevented | Receiver: Upon receiving the “alert” message, the |
| | break-ins. | receiver displayed three exclamation marks and |
| | | played a custom warning sound. Pressing button ‘A’ |
| | | stopped all sounds. |
| #4 | A Spider-Man-inspired glove that | On channel 45, Transceiver A: If button ‘A’ was |
| | launched an object when | pressed, transceiver A sent a “hi” message. If button |
| | receiving a signal. | ‘B’ was pressed or a “hello” message was received, |
| | | transceiver A displayed an intersection-shaped LED. |
| | | Transceiver B: When transceiver B received a |
| | | “hi” message, transceiver B played a “beep” sound |
| | | and activated pin 1 (servo motor). If button ‘A’ was |
| | | pressed, transceiver B sent a “hello” message, |
| | | displayed a dot-shaped LED, and deactivated pin 1 |
| | | (servo motor). |
| #5 | A device for visually impaired | Local Device (no wireless communication): When |
| | individuals that offered audio | button ‘A’ was pressed, the device activated pin 0 |
| | feedback when detecting nearby | (proximity sensor), measured the distance using a |
| | objects to prevent collisions. | ping with the trigger on pin 0, and echoed on pin 1, |
| | | set ‘distance’ to the measured value in centimeters, |
| | | displayed the ‘distance’, and paused for 1,000 ms. |

The experimental system facilitated iterative cycles of testing and refining during the development process. In each iteration, participants began by discussing how to implement their ideas using physical coding blocks. They then translated these blocks into MakeCode code utilizing the webcam. After reviewing and adjusting the code on the MakeCode platform, they downloaded the code to Micro:bit to observe and test the code's behavior (e.g., subpanel (c), FIG. 5B). This cycle repeated multiple times, allowing for continuous refinement of ideas and interaction designs (e.g., adjusting input values). For example, participants in group 3 frequently refined their code to better capture the shaking motion of a doorknob while opening the door. Some groups (e.g., 1, 2, 4) often revisited and adjusted their initial ideas using the physical blocks, while others (e.g., 3, 5) preferred modifying their code directly on the MakeCode platform after translating their code from the blocks. This flexibility facilitated participants to adapt their workflow based on their preferred working styles and prior experience. Overall, the use of the experimental system supported (and encouraged) iterative prototyping, enabling participants to engage with the development process using an accessible tool.

While future long-term research may be required to evaluate the extensibility of the experimental system, regarding how the experimental system supports sustained learning through accessible connected platforms, the evaluation results indicated promising potential. For example, groups 2 and 3 had ambitious project plans but could not finish them because of time constraints. Their ideas kept changing, and they wanted more time to improve their code on the MakeCode platform, but the experiment was too short. These teams asked if they could use online resources such as ChatGPT, YouTube, and Google to seek coding strategies (see subpanels (d)-(e), FIG. 5B). This demonstrated the participants' motivation for a deeper exploration of coding and how the experimental system's integration with online platforms (e.g., those with existing instructional resources) encouraged their continued learning. Similarly, a group 4 participant expressed eagerness to continue their projects and learning efforts beyond the experiment.

Additional Discussion. The exemplary/experimental system is inspired by the “low floor, high ceilings, wide walls” principles by Resnick & Silverman on construction kits, tools that engage children in creating things both on screens and in the physical world [64]. The study aimed to make learning programming feel like playing with construction kits while enabling continued exploration and expansion beyond initial activities. Current tangible programming systems reflect the notion of construction kits to some extent, yet the study focuses on finding a balance between the engaging nature of physical systems and their integration with online digital platforms.

The study's approach to bridging the digital and physical worlds extends beyond simply physicalizing digital systems, as discussed in Tangible User Interface (TUI) literature [12], [40], [73]. Due to the unique affordances of each medium, interactions designed for digital environments, such as mouse-based interfaces, do not always translate to physical interactions. For example, resizing blocks in a digital interface is straightforward but not feasible with physical blocks. Similarly, drag-and-drop interactions on online digital platforms, which help reduce cognitive load by displaying only relevant items at the right moment, may not be ideal for beginners who lack a mental model of the platform's structure and struggle to locate specific items. These insights guided the study to make interactions with physical coding blocks more comprehensible to navigate by leveraging the strengths of both physical and digital affordances and simplifying block designs.

The study integrated the exemplary system with an online platform (e.g., MakeCode) to support long-term learning for users (e.g., beginner-level), leveraging the online platform's capacity to facilitate projects ranging from simple programming tasks to advanced computing and engineering. The exemplary system can also bridge block-based coding and simplified versions of Python and JavaScript, enabling learners to progress to (or compare to) text-based coding without feeling overwhelmed. This extensibility, e.g., within the MakeCode ecosystem, may provide users a smooth transition from physical coding blocks to more advanced computing experiences, and set a focus on further lowering the entry barrier and expanding the learning modalities.

However, this approach to extensibility does not fully apply to human agency, underlying cultural contexts, and existing practices. Educators from the expert interviews emphasized the importance of minimizing the “mental distance” between learning stages to ensure that learners feel confident as they progress, thereby making extensibility meaningful. This stressed that each stage should not feel like “yet another new learning”. To gain deeper insights into the extensibility and adaptability of the envisioned technologies, future long-term studies may be needed to better understand the properties of system design and the learning activities preferred by both students and teachers.

One technical limitation of the exemplary/experimental system is its reliance on the Google Vision API [1] for extracting texts on physical coding blocks. During the experiment, participants captured images with distracting backgrounds (e.g., windows, hands), which led to misreadings by the API and caused errors in the text-to-code conversion. Although a clear backboard made of felt fabrics was provided to reduce these errors, background interference remained an issue. Furthermore, the low resolution of the Chromebooks used in the study further impacted text recognition accuracy, requiring participants to attempt multiple captures, which diminished their engagement over time. To address these challenges, future studies may explore enhancing the block-to-text process by optimizing block structures and text detection under varying conditions, including (i) refining noise handling within the image and (ii) ensuring consistent accuracy across different environments. Additionally, future studies should evaluate potential compiler enhancements to further increase the precision of image-to-code compilation. These improvements may streamline the user experience by reducing the need for multiple capture attempts and providing more reliable results.

### DISCUSSION

Tangible programming systems have provided beginner-friendly, playful, and collaborative approaches to learning programming by manipulating physical objects [17], [22], [34], [35], [41], [51], [55], [62], [63], [65], [71], [75], [83], [85]. However, these tools often function as standalone systems, which limits their integration with widely used platforms that could support ongoing and advanced learning. This isolation challenges the realization of the “low floor, high ceilings, wide walls” principles [59], [64], where systems are accessible for novices, foster diverse outcomes, and enable the development of more sophisticated projects.

A physical computing platform used in K-12 education is the Micro:bit board [32], paired with the Microsoft MakeCode software environment/platform [9]. The Micro:bit is an affordable microcontroller equipped with a built-in display, speaker, buttons, sensors, and Bluetooth Low Energy (BLE) radio technology, which reduces the need for circuit building while allowing for the addition of external components. Learners can program Micro:bit using various coding environments, including MakeCode, Arduino [11], and Python [78]. MakeCode is an online platform and web app that supports block-based coding, device simulation, and code downloading to microcontrollers, such as Micro:bit and Adafruit's Circuit Playground [2]. The combination of MakeCode and Micro:bit is adapted in K-12 educational activities, such as making wearables [43], battery-free devices [45], and robotics classrooms [18]. However, beginners often struggle to identify available functions and navigate menus to find relevant blocks, which can impede collaborative learning. To address these challenges, there is a need for a system that bridges tangible programming with the MakeCode/Micro:bit platforms, further lowering the entry barrier and enhancing collaboration while ensuring a connection to the MakeCode/Micro:bit for continued and advanced learning possibilities.

The study developed the exemplary system (“Tangible-MakeCode” (T-MC)), a tangible programming system, configured to translate physical coding block assemblies into programming code on an online platform/environment (e.g., Microsoft MakeCode). The exemplary system can comprise two parts: (i) physical coding blocks (e.g., made from printed paper attached to cardboard with no embedded electronics or power supplies) and (ii) a web-based interface that translates the physical block assemblies into programming code on an online platform (e.g., MakeCode). Users can take a picture of the tangible code blocks with a phone or webcam, upload it to the web-based interface, and generate code that can be pasted into the online platform environment, enabling them to download executable code to microcontroller boards (e.g., Micro:bit boards) for their physical computing projects. Although the exemplary system is developed for beginner learners of all ages, the study focused on middle school students (ages 12-14), as literature highlights the importance of engaging this age group to broaden participation in computing [28], [49].

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.
[1] 2024. Google Cloud Skills Boost: Machine Learning for Business Professionals. https://www.cloudskillsboost.google/course_templates/633. Accessed: 2024-09-12.
[2] Adafruit. 2021. Introducing Circuit Playground. https://learn.adafruit.com/introducing-circuit-playground/overview. Accessed: 2023-09-05.
[3] Diana Africano, Sara Berg, Kent Lindbergh, Peter Lundholm, Fredrik Nilbrink, and Anna Persson. 2004. Designing tangible interfaces for children's collaboration. In CHI '04 Extended Abstracts on Human Factors in Computing Systems (Vienna, Austria) (CHI EA '04). Association for Computing Machinery, New York, NY, USA, 853-868. https://doi.org/10.1145/985921.985945
[4] Behiye Akcay and Hakan Akcay. 2015. Effectiveness of Science-Technology-Society (STS) Instruction on Student Understanding of the Nature of Science and Attitudes toward Science. International Journal of Education in Mathematics, Science and Technology 3, 1 (2015), 37-45.
[5] Monica Anderson and Jingjing Jiang. 2018. Teens, social media & technology 2018. Technical Report. Pew Research Center. https://apo.org.au/node/175701
[6] Alissa N Antle and Alyssa F Wise. 2013. Getting down to details: Using theories of cognition and learning to inform tangible user interface design. Interacting with Computers 25, 1 (2013), 1-20.
[7] Sung-Man Bae. 2019. The relationship between smartphone use for communication, social capital, and subjective well-being in Korean adolescents: Verification using multiple latent growth modeling. Children and Youth Services Review 96 (2019), 93-99. https://doi.org/10.1016/j.childyouth.2018. 11.032
[8] S. Bakker, A. N. Antle, and E. v. d. Hoven. 2011. Embodied metaphors in tangible interaction design. Personal and Ubiquitous Computing 16, 4 (2011), 433-449. https://doi.org/10.1007/s00779-011-0410-4
[9] Thomas Ball, Abhijith Chatra, Peli de Halleux, Steve Hodges, Michal Moskal, and Jacqueline Russell. 2019. Microsoft MakeCode: embedded programming for education, in blocks and TypeScript. In Proceedings of the 2019 ACM SIGPLAN Symposium on SPLASH-E (Athens, Greece)(SPLASH-E 2019). Association for Computing Machinery, New York, NY, USA, 7-12. https://doi.org/10.1145/3358711.3361630
[10] Massimo Banzi. 2011. Getting started with Arduino. O'Reilly Media, Inc., Sebastopol, CA.
[11] M. Banzi and M. Shiloh. 2014. Getting Started with Arduino: The Open Source Electronics Prototyping Platform. Maker Media, Inc., Sebastopol, CA.
[12] Mark Baskinger and Mark Gross. 2010. COVER STORYTangible interaction=form+computing. Interactions 17, 1 (jan 2010), 6-11. https://doi.org/10.1145/1649475.1649477
[13] Ayah Bdeir. 2009. Electronics as material: littleBits. In Proceedings of the 3rd International Conference on Tangible and Embedded Interaction (Cambridge, United Kingdom) (TEI '09). Association for Computing Machinery, New York, NY, USA, 397-400. https://doi.org/10. 1145/1517664.1517743
[14] Paulo Blikstein. 2013. Gears of our childhood: constructionist toolkits, robotics, and physical computing, past and future. In Proceedings of the 12th International Conference on Interaction Design and Children (New York, New York, USA) (IDC '13). Association for Computing Machinery, New York, NY, USA, 173-182. https://doi.org/10.1145/2485760.2485786
[15] Nicholas A. Bowman, Lindsay Jarratt, K. C. Culver, and Alberto Maria Segre. 2019. How Prior Programming Experience Affects Students' Pair Programming Experiences and Outcomes. In Proceedings of the 2019 ACM Conference on Innovation and Technology in Computer Science Education (Aberdeen, Scotland Uk) (ITiCSE '19). Association for Computing Machinery, New York, NY, USA, 170-175. https://doi.org/10.1145/3304221.3319781
[16] Gongalo Cardoso, Ana Cristina Pires, Lúcia Verónica Abreu, Filipa Rocha, and Tiago Guerreiro. 2021. LEGOWorld: Repurposing Commodity Tools & Technologies to Create an Accessible and Customizable Programming Environment. In Extended Abstracts of the 2021 CHI Conference on Human Factors in Computing Systems (Yokohama, Japan) (CHI EA '21). Association for Computing Machinery, New York, NY, USA, Article 273, 6 pages. https://doi.org/10.1145/3411763.3451710
[17] Kunal Chawla, Megan Chiou, Alfredo Sandes, and Paulo Blikstein. 2013. Dr. Wagon: a ‘stretchable’ toolkit for tangible computer programming. In Proceedings of the 12th International Conference on Interaction Design and Children. ACM, New York, NY, USA, 561-564.
[18] Po-Jen Cheng, Yuan-Hsun Liao, and Pao-Ta Yu. 2021. Micro: bit robotics course: infusing logical reasoning and problem-solving ability in fifth grade students through an online group study system. International Review of Research in Open and Distributed Learning 22, 1 (2021), 21-40.
[19] Quentin Chibaudel, Wafa Johal, Bernard Oriola, Marc J-M Macé, Pierre Dillenbourg, Valérie Tartas, and Christophe Jouffrais. 2020. “If you've gone straight, now, you must turn left”—Exploring the use of a tangible interface in a collaborative treasure hunt for people with visual impairments. In Proceedings of the 22nd International ACM SIGACCESS Conference on Computers and Accessibility (Virtual Event, Greece) (ASSETS '20). Association for Computing Machinery, New York, NY, USA, Article 19, 10 pages. https://doi.org/10.1145/3373625.3417020
[20] Code.org. 2023. State of Computer Science Education. Technical Report. Code.org.
[21] N. Dahlbäck, A. Jönsson, and L. Ahrenberg. 1993. Wizard of Oz studies—why and how. Knowledge-Based Systems 6, 4 (1993), 258-266. https://doi.org/10.1016/0950-7051(93)90017-N Special Issue: Intelligent User Interfaces.
[22] Xiaozhou Deng, Danli Wang, and Jin Qiao. 2019. TLogic: A Tangible Programming Tool to Help Children Solve Problems. In Lecture Notes in Computer Science. Springer, Cham, 255-262. https://doi.org/10.1007/978-3-030-23712-7_35
[23] Jennifer DeWitt and Louise Archer. 2015. Who aspires to a science career? A comparison of survey responses from primary and secondary school students. International Journal of Science Education 37, 13 (2015), 2170-2192.
[24] Monica Divitini, Michail N. Giannakos, Simone Mora, Sofia Papavlasopoulou, and Ole Sejer Iversen. 2017. Make2Learn with IoT: Engaging Children into Joyful Design and Making of Interactive Connected Objects. In Proceedings of the 2017 Conference on Interaction Design and Children (Stanford, California, USA) (IDC '17). Association for Computing Machinery, New York, NY, USA, 757-760. https://doi.org/10.1145/3078072.3081312
[25] Min Fan, Alissa N. Antle, Carman Neustaedter, and Alyssa F. Wise. 2014. Exploring How a Co-dependent Tangible Tool Design Supports Collaboration in a Tabletop Activity. In Proceedings of the 2014 ACM International Conference on Supporting Group Work (Sanibel Island, Florida, USA) (GROUP '14). Association for Computing Machinery, New York, NY, USA, 81-90. https://doi.org/10.1145/2660398.2660402
[26] George W Fitzmaurice, Hiroshi Ishii, and William A S Buxton. 1995. Bricks: laying the foundations for graspable user interfaces. In Proceedings of the SIGCHI Conference on Human Factors in Computing Systems. ACM Press/Addison-Wesley Publishing Co., New York, NY, USA, 442-449.
[27] Rosella Gennari, Alessandra Melonio, Mehdi Rizvi, and Andrea Bonani. 2017. Design of IoT Tangibles for Primary Schools: A Case Study. In Proceedings of the 12th Biannual Conference on Italian SIGCHI Chapter (Cagliari, Italy) (CHItaly '17). Association for Computing Machinery, New York, NY, USA, Article 26, 6 pages. https://doi.org/10.1145/3125571.3125591
[28] Shuchi Grover, Roy Pea, and Stephen Cooper. 2014. Remedying misperceptions of computer science among middle school students. In Proceedings of the 45th ACM Technical Symposium on Computer Science Education (Atlanta, Georgia, USA) (SIGCSE '14). Association for Computing Machinery, New York, NY, USA, 343-348. https://doi.org/10.1145/2538862.2538934
[29] Shuchi Grover, Roy Pea, and Stephen Cooper. 2014. Remedying misperceptions of computer science among middle school students. In Proceedings of the 45th ACM Technical Symposium on Computer Science Education (Atlanta, Georgia, USA) (SIGCSE '14). Association for Computing Machinery, New York, NY, USA, 343-348. https://doi.org/10.1145/2538862.2538934
[30] Mona Leigh Guha, Allison Druin, and Jerry Alan Fails. 2013. Cooperative Inquiry revisited: Reflections of the past and guidelines for the future of intergenerational co-design. International Journal of Child-Computer Interaction 1, 1 (2013), 14-23. https://doi.org/10.1016/j.ijcci.2012.08.003
[31] Hasan Güleryüz. 2023. Attitudes of secondary school students towards robotics and coding in stem education with tinkercad. Bayburt Eğitim Fakültesi Dergisi 18, 38 (2023), 471-485.
[32] Gareth Halfacree. 2017. The official BBC Micro: bit user guide. John Wiley & Sons, 9600 Garsington Road Oxford, England.
[33] Steve Hodges, Sue Sentance, Joe Finney, and Thomas Ball. 2020. Physical Computing: A Key Element of Modern Computer Science Education. Computer 53, 4 (2020), 20-30. https://doi.org/10.1109/MC.2019.2935058
[34] Michael S Horn. 2018. Tangible interaction and cultural forms: Supporting learning in informal environments. Journal of the Learning Sciences 27, 4 (2018), 632-665.
[35] Michael S Horn, R Jordan Crouser, and Marina U Bers. 2012. Tangible interaction and learning: the case for a hybrid approach. Personal and Ubiquitous Computing 16 (2012), 379-389.
[36] Michael S Horn, R Jordan Crouser, and Marina U Bers. 2012. Tangible interaction and learning: the case for a hybrid approach. Personal and Ubiquitous Computing 16 (2012), 379-389.
[37] Michael S. Horn and Robert J. K. Jacob. 2007. Tangible programming in the classroom with tern. In CHI '07 Extended Abstracts on Human Factors in Computing Systems (San Jose, CA, USA) (CHI EA '07). Association for Computing Machinery, New York, NY, USA, 1965-1970. https://doi.org/10.1145/1240866.1240933
[38] Felix Hu, Ariel Zekelman, Michael Horn, and Frances Judd. 2015. Strawbies: explorations in tangible programming. In Proceedings of the 14th International Conference on Interaction Design and Children. ACM, New York, NY, USA, 410-413.
[39] Hyejin Im and Chris Rogers. 2021. Draw2code: Low-cost tangible programming for creating ar animations. In Proceedings of the 20th Annual ACM Interaction Design and Children Conference. ACM, Athens, Greece, 427-432.
[40] H. Ishii and B. Ullmer. 1997. Tangible bits: towards seamless interfaces between people, bits and atoms. In Proceedings of the ACM SIGCHI Conference on Human Factors in Computing Systems. ACM, New York, NY, USA, 234-241. https://doi.org/10.1145/258549.258715
[41] Qiao Jin, Danli Wang, Haoran Yun, and Svetlana Yarosh. 2023. Shape of Music: AR-based Tangible Programming Tool for Music Visualization. In Proceedings of the 22nd Annual ACM Interaction Design and Children Conference. Association for Computing Machinery, New York, NY, USA, 647-651.
[42] KinderLab Robotics. 2024. KIBO Robot Kit. https://kinderlabrobotics.com/kibo/[Accessed: 10 Sep. 2024].
[43] Nika Klimovi. 2020. Wearables: Educational Projects Made with the BBC micro: bit. In 2020 18th International Conference on Emerging eLearning Technologies and Applications (ICETA). IEEE, IEEE, Piscataway, NJ, 323-329.
[44] Varsha Koushik, Darren Guinness, and Shaun K Kane. 2019. Storyblocks: A tangible programming game to create accessible audio stories. In Proceedings of the 2019 CHI Conference on Human Factors in Computing Systems. ACM, Glasgow, Scotland, UK, 1-12.
[45] Christopher Kraemer, Amy Guo, Saad Ahmed, and Josiah Hester. 2022. Battery-free MakeCode: Accessible Programming for Intermittent Computing. Proc. ACM Interact. Mob. Wearable Ubiquitous Technol. 6, 1, Article 18 (mar 2022), 35 pages. https://doi.org/10. 1145/3517236
[46] Mario Lawes, Clemens Hetschko, Joseph W Sakshaug, and Stephan Grießemer. 2022. Contact modes and participation in app-based smartphone surveys: Evidence from a large-scale experiment. Social Science Computer Review 40, 5 (2022), 1076-1092.
[47] J. Lee, J. Oh, and J. Kim. 2023. My:Talkies: A Toolkit for Children to Learn Basic Communication Systems. (2023), 1-18.
[48] Sangmin-Michelle Lee. 2019. Her story or their own stories? Digital game-based learning, student creativity, and creative writing. ReCALL 34, 3 (2019), 238-254.
[49] Robert W Lent, Steven D Brown, and Gail Hackett. 1994. Toward a unifying social cognitive theory of career and academic interest, choice, and performance. Journal of vocational behavior 45, 1 (1994), 79-122.
[50] Debora Lui, Yasmin Kafai, Breanne Litts, Justice Walker, and Sari Widman. 2020. Pair physical computing: high school students' practices and perceptions of collaborative coding and crafting with electronic textiles. Computer Science Education 30, 1 (2020), 72-101.
[51] Timothy S McNerney. 1999. Tangible programming bricks: An approach to making programming accessible to everyone. Ph. D. Dissertation. Massachusetts Institute of Technology.
[52] Aditya Mehrotra, Christian Giang, Noé Duruz, Julien Dedelley, Andrea Mussati, Melissa Skweres, and Francesco Mondada. 2020. Introducing a paper-based programming language for computing education in classrooms. In Proceedings of the 2020 ACM conference on innovation and technology in computer science education. ACM, New York, NY, USA, 180-186.
[53] Roger Meintjes, Thembelani Makapela, Micyla Hobbs, and Nandipha Jantjies. 2023. Child-to-Child Public Health Messaging through a Portable Craft Tech Interactive in Rural South Africa. In Proceedings of the 22nd Annual ACM Interaction Design and Children Conference (Chicago, IL, USA)(IDC '23). Association for Computing Machinery, New York, NY, USA, 210-221. https://doi.org/10.1145/3585088.3589372
[54] Edward Melcer and Katherine Isbister. 2017. Embodiment, collaboration, and challenge in educational programming games: exploring use of tangibles and mouse. In Proceedings of the 12th International Conference on the Foundations of Digital Games. ACM, New York, NY, USA, 1-6.
[55] Hyunjoo Oh, Anisha Deshmane, Feiran Li, Ji Yeon Han, Matt Stewart, Michael Tsai, Xing Xu, and Ian Oakley. 2013. The digital dream lab: tabletop puzzle blocks for exploring programmatic concepts. In Proceedings of the 7th International Conference on Tangible, Embedded and Embodied Interaction (Barcelona, Spain) (TEI '13). Association for Computing Machinery, New York, NY, USA, 51-56. https://doi.org/10.1145/2460625.2460633
[56] Hyunjoo Oh, Anisha Deshmane, Feiran Li, Ji Yeon Han, Matt Stewart, Michael Tsai, Xing Xu, and Ian Oakley. 2013. The digital dream lab: tabletop puzzle blocks for exploring programmatic concepts. In Proceedings of the 7th International Conference on Tangible, Embedded and Embodied Interaction (Barcelona, Spain) (TEI '13). Association for Computing Machinery, New York, NY, USA, 51-56. https://doi.org/10.1145/2460625.2460633
[57] Allan Paivio. 1991. Dual coding theory: Retrospect and current status. Canadian Journal of Psychology/Revue canadienne de psychologie 45, 3 (1991), 255.
[58] Seymour Papert. 1980. Mindstorms: Children, computers, and powerful ideas. Basic Books, Inc., New York, NY.
[59] Seymour Papert. 1993. The children's machine: Rethinking school in the age of the computer. Basic Books, New York.
[60] Jeong Hye Park and Minjung Park. 2021. Smartphone use patterns and problematic smartphone use among preschool children. PloS one 16, 3 (2021), e0244276.
[61] Mareen Przybylla and Ralf Romeike. 2014. Physical Computing and Its Scope-Towards a Constructionist Computer Science Curriculum with Physical Computing. Informatics in Education 13, 2 (2014), 241-254.
[62] Krithik Ranjan, Peter Gyory, Michael L Rivera, and Ellen Yi-Luen Do. 2023. Cartoonimator: A Low-cost, Paper-based Animation Kit for Computational Thinking. In Proceedings of the 22nd Annual ACM Interaction Design and Children Conference. ACM, New York, NY, USA, 517-521.
[63] Mitchel Resnick. 1993. Behavior construction kits. Commun. ACM 36, 7 (1993), 64-71.
[64] Mitchel Resnick and Brian Silverman. 2005. Some reflections on designing construction kits for kids. In Proceedings of the 2005 Conference on Interaction Design and Children (Boulder, Colorado) (IDC '05). Association for Computing Machinery, New York, NY, USA, 117-122. https://doi.org/10.1145/1109540.1109556
[65] Alpay Sabuncuoglu and Metin Sezgin. 2022. Kart-ON: An Extensible Paper Programming Strategy for Affordable Early Programming Education. Proceedings of the ACM on Human-Computer Interaction 6, EICS (2022), 1-18.
[66] T. Sapounidis, I. Stamelos, and S. Demetriadis. 2016. Tangible user interfaces for programming and education: A new field for innovation and entrepreneurship. Innovation and Entrepreneurship in Education 2 (2016), 271-295. https://doi.org/10.1108/S2051-229520160000002016
[67] Cass Scheirer, Vera Zhong, Sakshi Kulkarni, Mashiyat Zaman, Kayla Desportes, and Francisco Enrique Vicente Castro. 2024. touchBase: A Tangible Programming Language for Physical Computing. In Proceedings of the 16th Conference on Creativity & Cognition (Chicago, IL, USA). Association for Computing Machinery, New York, NY, USA, 464-469. https://doi.org/10.1145/3635636.3664253
[68] R A Schmuck and P A Schmuck. 1975. Group Processes in the Classroom Second Edition. WM. C.
[69] Bertrand Schneider and Paulo Blikstein. 2015. Using exploratory tangible user interfaces for supporting collaborative learning of probability. IEEE Transactions on Learning Technologies 8, 4 (2015), 424-435.
[70] Eric Schweikardt and Mark D. Gross. 2006. roBlocks: a robotic construction kit for mathematics and science education. In Proceedings of the 8th International Conference on Multimodal Interfaces (Banff, Alberta, Canada) (ICMI '06). Association for Computing Machinery, New York, NY, USA, 72-75. https://doi.org/10.1145/1180995.1181010
[71] Yasaman S. Sefidgar, Thomas Weng, Heather Harvey, Sarah Elliott, and Maya Cakmak. 2018. RobotIST: Interactive Situated Tangible Robot Programming. In Proceedings of the 2018 ACM Symposium on Spatial User Interaction (Berlin, Germany) (SUI '18). Association for Computing Machinery, New York, NY, USA, 141-149. https://doi.org/10.1145/3267782.3267921
[72] Sue Sentance, Jane Waite, Lucy Yeomans, and Emily MacLeod. 2017. Teaching with physical computing devices: the BBC micro: bit initiative. In Proceedings of the 12th Workshop on Primary and Secondary Computing Education. ACM, New York, NY, USA, 87-96.
[73] Orit Shaer and Eva Hornecker. 2010. Tangible User Interfaces: Past, Present and Future Directions. Vol. 3. Now Publishers Inc, Hanover, MA, USA. 1-137 pages. https://doi.org/10.1561/1100000026
[74] Hideyuki Suzuki and Hiroshi Kato. 1993. AlgoBlock: a tangible programming language, a tool for collaborative learning. In Proceedings of 4th European Logo Conference. European Logo Foundation, Athens, Greece, 297-303.
[75] Katerina Tsarava, Korbinian Moeller, Niels Pinkwart, Martin Butz, Ulrich Trautwein, and Manuel Ninaus. 2017. Training computational thinking: Game-based unplugged and plugged-in activities in primary school. In Proceedings of the 11th European Conference on Game-Based Learning. Academic Conferences International Limited, Academic Conferences and Publishing International Limited, Reading, UK, 687-695.
[76] Eben Upton and Gareth Halfacree. 2016. Raspberry Pi user guide. John Wiley & Sons, Hoboken, NJ.
[77] Maarten Van Mechelen, Bieke Zaman, Ann Laenen, and Vero Vanden Abeele. 2015. Challenging group dynamics in participatory design with children: Lessons from social interdependence theory. In Proceedings of the 14th International Conference on Interaction Design and Children. ACM, New York, NY, USA, 219-228.
[78] Guido Van Rossum and Fred L Drake Jr. 1995. Python tutorial. Python Software Foundation.
[79] Torben Wallbaum, Swamy Ananthanarayan, Andrii Matviienko, and Susanne Boll. 2020. A Real-time Distributed Toolkit to Ease Children's Exploration of IoT. In Proceedings of the 11th Nordic Conference on Human-Computer Interaction: Shaping Experiences, Shaping Society (Tallinn, Estonia) (NordiCHI '20). Association for Computing Machinery, New York, NY, USA, Article 9, 9 pages. https://doi.org/10.1145/3419249.3420179
[80] Greg Walsh, Alison Druin, Mona Leigh Guha, Elizabeth Foss, Evan Golub, Leshell Hatley, Elizabeth Bonsignore, and Sonia Franckel. 2010. Layered elaboration: a new technique for co-design with children. In Proceedings of the SIGCHI Conference on Human Factors in Computing Systems (Atlanta, Georgia, USA) (CHI '10). Association for Computing Machinery, New York, NY, USA, 1237-1240. https://doi.org/10.1145/1753326.1753512
[81] Danli Wang, Yanyan Zhao, and Shuo Feng. 2022. AR-C&P: A Tangible Programming for Children Based Augmented Reality. In Proceedings of the Tenth International Symposium of Chinese CHI. ACM, New York, NY, USA, 141-150.
[82] Jayce R. Warner, Joshua Childs, Carol L. Fletcher, Nicole D. Martin, and Michelle Kennedy. 2021. Quantifying Disparities in Computing Education: Access, Participation, and Intersectionality. In Proceedings of the 52nd ACM Technical Symposium on Computer Science Education (Virtual Event, USA) (SIGCSE '21). Association for Computing Machinery, New York, NY, USA, 619-625. https://doi.org/10.1145/3408877.3432392
[83] Peta Wyeth and Gordon F Wyeth. 2001. Electronic blocks: Tangible programming elements for preschoolers. In Human-Computer Interaction INTERACT '01: IFIP TC13 International Conference on Human-Computer Interaction. IOS Press, Tokyo, Japan, 496-503.
[84] Bieke Zaman, Vero Vanden Abeele, Panos Markopoulos, and Paul Marshall. 2012. The evolving field of tangible interaction for children: the challenge of empirical validation; 367-378 pages.
[85] Oren Zuckerman, Saeed Arida, and Mitchel Resnick. 2005. Extending tangible interfaces for education: digital montessori-inspired manipulatives. In Proceedings of the SIGCHI conference on Human factors in computing systems. ACM, New York, NY, USA, 859-868.

What is claimed:

1. A kit comprising:
a plurality of physical coding blocks for a kit of programmable coding blocks having observable correspondence to coding blocks in a software development environment, including a first physical coding block having an observable correspondence to a first coding block in the software development environment, a second physical coding block having an observable correspondence to a second coding block in the software development environment, and a third physical coding block having an observable correspondence to a third coding block in the software development environment, wherein the first coding block in the software development environment and the first physical coding block has a first associated programming function, wherein the second coding block in the software development environment and the second physical coding block has a second associated programming function, wherein the third coding block in the software development environment and the third physical coding block has a third associated programming function,
wherein the first physical coding block has a first shaped surface and a second shaped surface, wherein the second physical coding block has a third shaped surface configured to attachably and re-attachably assemble with the first shaped surface of the first physical coding block and the third physical coding block has a fourth shaped surface to attachably and re-attachably assemble with the second shaped surface of the first physical coding block, to form a coding block assembly, wherein the assembly combines the associated programming functions in a sequence having correspondence to a combined sequence of the first coding block, the second coding block, and the third coding block in the software development environment, and
wherein an image acquired of the assembly of the first physical coding block with the second physical coding block and the third physical coding block is used to generate computer compilable or interpretable code in the software development environment having the programming functions in the sequence having correspondence to the combined sequence of the first coding block, the second coding block, and the third coding block, and wherein the compilable or interpretable code in the software development environment is compiled or interpreted to generate computer-readable instructions for execution on an electronic device.

2. The kit of claim 1, wherein the image acquired of the assembly of the first physical coding block with the second physical coding block and the third physical coding block by an intermediate computing device is used to generate the computer compilable or interpretable code at the intermediate computing device to be imported into the software development environment for compiling.

3. The kit of claim 1, wherein the image acquired of the assembly of the first physical coding block with the second physical coding block and the third physical coding block by an intermediate computing device is used to generate, at the intermediate computing device, computer-readable instructions for execution on the electronic device.

4. The kit of claim 1, wherein the observable correspondence of each physical coding block to a respective coding block in the software development environment includes text, relative positioning, spatial arrangement, or a combination thereof representing a respective programming function in the software development environment.

5. The kit of claim 2, wherein the generation of the compilable or interpretable code at the intermediate computing device comprises:
generating, via an image recognition or image-to-text translation model, an instruction object/structure having the programming functions in a sequence having correspondence to the combined sequence of the first coding block, the second coding block, and the third coding block; and
generating, via a processor, the compilable or interpretable code having the programming functions in the sequence having correspondence to the combined sequence, using the generated instruction object/structure,
wherein the compilable or interpretable code is imported into the software development environment to be compiled or interpreted to generate the computer-readable instructions for execution on the electronic device.

6. The kit of claim 3, wherein the generation of the computer-readable instructions at the intermediate computing device comprises:
generating, via an image recognition or image-to-text translation model, an instruction object/structure having the programming functions in a sequence having correspondence to the combined sequence of the first coding block, the second coding block, and the third coding block; and
generating, via a processor, the computer-readable instructions for execution on the electronic device, using the generated instruction object/structure.

7. A system comprising:
a kit comprising a plurality of physical coding blocks, each having an observable correspondence to a respective coding block in a software development environment, each respective coding block having an associated programming function; and
an intermediate computing device comprising:
a processor; and
a memory having instructions stored thereon, wherein execution of the instructions causes the processor to:
receive, via an interface, an image of a coding block assembly;
generate, via an image recognition or image-to-text translation model, an instruction object/structure representing programming functions in a sequence having correspondence to a combined sequence of physical coding blocks in the assembly; and
generate, using the generated instruction object/structure, compilable or interpretable code having the programming functions in the sequence,
wherein the compilable or interpretable code is imported into the software development environment to be compiled or interpreted to generate computer-readable instructions for execution on an electronic device.

8. The system of claim 7, wherein the plurality of physical coding blocks includes:
a first physical coding block having an observable correspondence to a first coding block in the software development environment;
a second physical coding block having an observable correspondence to a second coding block in the software development environment; and
a third physical coding block having an observable correspondence to a third coding block in the software development environment.

9. The system of claim 8, wherein:
the first physical coding block has a first shaped surface and a second shaped surface;
the second physical coding block has a third shaped surface configured to attachably and re-attachably assemble with the first shaped surface of the first physical coding block; and
the third physical coding block has a fourth shaped surface configured to attachably and re-attachably assemble with the second shaped surface of the first physical coding block, to form the assembly, wherein the assembly combines associated programming functions in a sequence having correspondence to a combined sequence of the first, second, and third coding blocks in the software development environment.

10. The system of claim 7, wherein the execution of the instructions further causes the processor to:
generate, via the processor, the computer-readable instructions for execution on the electronic device, using the generated instruction object/structure.

11. The system of claim 7, wherein the observable correspondence of each physical coding block to a respective coding block in the software development environment includes text, relative positioning, spatial arrangement, or a combination thereof representing a respective programming function in the software development environment.

12. A non-transitory computer-readable medium having instructions stored thereon, wherein execution of the instructions by a processor causes the processor to:
receive, via an interface, an image of a coding block assembly comprising a plurality of physical coding blocks, each having an observable correspondence to a respective coding block in a software development environment;
generate, via an image recognition or image-to-text translation model, an instruction object/structure representing a sequence of programming functions having correspondence to a combined sequence of the physical coding blocks in the assembly; and
generate, via the processor, compilable or interpretable code having the programming functions in the sequence having correspondence to the combined sequence of the physical coding blocks in the assembly, using the generated instruction object/structure,
wherein the compilable or interpretable code is imported into the software development environment to be compiled or interpreted to generate computer-readable instructions for execution on an electronic device.

13. The non-transitory computer-readable medium of claim 12, wherein the coding block assembly comprises:
a first physical coding block having an observable correspondence to a first coding block in the software development environment, the first coding block having a first associated programming function;
a second physical coding block having an observable correspondence to a second coding block in the software development environment, the second coding block having a second associated programming function; and
a third physical coding block having an observable correspondence to a third coding block in the software development environment, the third coding block having a third associated programming function.

14. The non-transitory computer-readable medium of claim 13, wherein:
the first physical coding block has a first shaped surface and a second shaped surface;
the second physical coding block has a third shaped surface configured to attachably and re-attachably assemble with the first shaped surface of the first physical coding block; and
the third physical coding block has a fourth shaped surface configured to attachably and re-attachably assemble with the second shaped surface of the first physical coding block, to form the assembly, wherein the assembly combines associated programming functions in a sequence having correspondence to the combined sequence of the first, second, and third coding blocks in the software development environment.

15. The non-transitory computer-readable medium of claim 12, wherein the execution of the instructions further causes the processor to:
generate, via the processor, the computer-readable instructions for execution on the electronic device, using the generated instruction object/structure.

16. The non-transitory computer-readable medium of claim 12, wherein the observable correspondence of each physical coding block to a respective coding block in the software development environment includes text, relative positioning, spatial arrangement, or a combination thereof representing a respective programming function in the software development environment.

17. A method comprising:
receiving, via an interface, an image of a coding block assembly comprising a plurality of physical coding blocks, each having an observable correspondence to a respective coding block in a software development environment;
generating, via an image recognition or image-to-text translation model, an instruction object/structure representing a sequence of programming functions having correspondence to a combined sequence of the physical coding blocks in the assembly; and
generating, via the processor, compilable or interpretable code having the programming functions in the sequence having correspondence to the combined sequence of the physical coding blocks in the assembly, using the generated instruction object/structure,
wherein the compilable or interpretable code is imported into the software development environment to be compiled or interpreted to generate computer-readable instructions for execution on an electronic device.

18. The method of claim 17, wherein the coding block assembly comprises:
a first physical coding block having an observable correspondence to a first coding block in the software development environment, the first coding block having a first associated programming function;
a second physical coding block having an observable correspondence to a second coding block in the software development environment, the second coding block having a second associated programming function; and
a third physical coding block having an observable correspondence to a third coding block in the software development environment, the third coding block having a third associated programming function.

19. The method of claim 17, comprising:
generating, via the processor, the computer-readable instructions for execution on the electronic device, using the generated instruction object/structure.

20. The method of claim 17, wherein the observable correspondence of each physical coding block to a respective coding block in the software development environment includes text, relative positioning, spatial arrangement, or a combination thereof representing a respective programming function in the software development environment.
